(19) United States
(12) Patent Application Publication
(10) Pub. No.: US 2025/0170543 A1
(43) Pub. Date: May 29, 2025

(54) COMPONENTS, ASSEMBLIES, AND DEVICES HAVING A CATALYST

(71) Applicant: General Electric Company, Schenectady, NY (US)

(72) Inventors: Dustin Sheinberg, Cincinnati, OH (US); Jeffrey D. Rambo, Mason, OH (US); Steven M. Szczap, West Chester, OH (US); Sean Binion, Loveland, OH (US); Christopher J. Kroger, West Chester, OH (US); Lawrence B. Kool, Clifton Park, NY (US)

(21) Appl. No.: 18/521,315

(22) Filed: Nov. 28, 2023

(51) Int. Cl. B01J 4/00; B01J 8/02; B01J 23/42; B01J 23/44; B01J 35/45

(52) U.S. Cl. CPC B01J 4/001; B01J 8/02; B01J 23/42; B01J 23/44; B01J 35/45

(57) ABSTRACT

A component includes a conduit region having a flow path to convey a fluid including a reactive compound, a connector region having an external surface and a joining surface to fluidly connect the conduit region to another component, and a catalyst having a platinum group metal. The catalyst is positioned on at least one surface chosen from the joining surface of the connector region, the external surface of the connector, and combinations thereof. The flow path is free of the catalyst and the catalyst is positioned to contact and to react the reactive compound if the reactive compound escapes the flow path.

### TECHNICAL FIELD

The present disclosure relates generally to components and systems for conveying a fuel such as hydrogen, and more particularly, to fuel systems for a gas turbine engine for aircraft.

### BACKGROUND

Propulsion systems for some commercial aircraft may include one or more aircraft engines, such as turbofan jet engines. The turbofan jet engine(s) may be mounted to a respective one of the wings of the aircraft, such as in a suspended position beneath the wing using a pylon. These engines may be powered by aviation turbine fuel, which may include a combustible hydrocarbon liquid fuel, such as a kerosene-type fuel, having a desired carbon number. Aviation turbine fuel is a relatively power-dense fuel that is relatively easy to transport and stays in a liquid phase through many ambient operating conditions. Aviation turbine fuel produces carbon dioxide upon combustion, and improvements to reduce carbon dioxide emissions in commercial aircraft are desired such as by using a fuel including diatomic hydrogen.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic view of an aircraft having a fuel system including diatomic hydrogen according to an embodiment of the present disclosure.

FIG. 2 is a schematic, cross-sectional view, taken along line 2-2 in FIG. 1, of a gas turbine engine of the aircraft shown in FIG. 1.

FIG. 3 is a schematic view of a fuel system according to an embodiment of the present disclosure.

FIG. 4A is a schematic view of a flange-type component and/or an assembly having a flow path and a hydrogen reaction catalyst according to an embodiment of the present disclosure.

FIG. 4B is an end view of the flange-type component and/or an assembly of FIG. 4A.

FIG. 4C is a cross-sectional view of the flange-type component and/or the assembly shown in FIG. 4B taken along line 4C-4C in FIG. 4B.

FIG. 4D is a cross-sectional view of a flange-type component and/or an assembly having a flow path and a hydrogen reaction catalyst according to an embodiment of the present disclosure.

FIG. 4E is a cross-sectional view of a flange-type component and/or an assembly having a flow path and a hydrogen reaction catalyst according to an embodiment of the present disclosure.

FIG. 4F is a schematic view of a flange-type component and/or an assembly having a flow path and a hydrogen reaction catalyst according to an embodiment of the present disclosure.

FIG. 4G is an end view of the flange-type component and/or an assembly of FIG. 4F taken in the direction of line 4G-4G shown in FIG. 4F.

FIG. 5A is a cross-sectional view of a component and/or an assembly having a flow path and a hydrogen reaction catalyst located in an enclosed volume.

FIG. 5B is a cross-sectional view of a component and/or an assembly having a flow path and a hydrogen reaction catalyst located in an enclosed volume, e.g., including a tortuous path, according to an embodiment of the present disclosure.

FIG. 5C is a detail, cross-sectional view of the component and/or assembly shown in FIG. 5B, showing detail 5C in FIG. 5B.

FIG. 5D is a cross-sectional view of a component and/or an assembly having a flow path and a hydrogen reaction catalyst located in an enclosed volume.

FIG. 5E is a detail, cross-sectional view of the component and/or assembly shown in FIG. 5D, showing detail 5E in FIG. 5D.

FIG. 5F is an end view of the flange-type component and/or an assembly of FIG. 5D taken in the direction of line 5F-5F shown in FIG. 5D.

FIG. 6 is a cross-sectional view of a component and/or an assembly having a flow path and a hydrogen reaction catalyst located in a recession and/or a protrusion according to an embodiment of the present disclosure.

FIG. 7A is a cross-sectional view of an assembly having three components and a hydrogen reaction catalyst located on the third component according to an embodiment of the present disclosure.

FIG. 7B is a cross-sectional view of an assembly having three components and a hydrogen reaction catalyst located on the third component according to an embodiment of the present disclosure.

FIG. 7C is a cross-sectional view of an assembly having three components and a hydrogen reaction catalyst located on the third component according to an embodiment of the present disclosure.

FIG. 8 is a cross-sectional view of a component and/or an assembly having a bayonet connector and a hydrogen reaction catalyst located on a piston seal according to an embodiment of the present disclosure.

FIG. 9A is a cross-sectional view of an assembly having three components and a hydrogen reaction catalyst located on the third component according to an embodiment of the present disclosure.

FIG. 9B is a cross-sectional view of an assembly having three components and a hydrogen reaction catalyst located on the third component according to an embodiment of the present disclosure.

FIG. 9C is a cross-sectional view of an assembly having three components and a hydrogen reaction catalyst located on the third component according to an embodiment of the present disclosure.

FIG. 10 is a cross-sectional view of an assembly having flange connectors, a component, such as a bolt, connecting the flange connectors, and a hydrogen reaction catalyst located on the component connecting the flange connectors according to an embodiment of the present disclosure.

FIG. 11A is a cross-sectional view of an assembly having two components in fluid communication and a hydrogen reaction catalyst located at a connection region of the two components according to an embodiment of the present disclosure.

FIG. 11B is a cross-sectional view of an assembly having two components in fluid communication and a hydrogen reaction catalyst located at a connection region of the two components according to an embodiment of the present disclosure.

FIG. 12 is a cross-sectional view of a double-walled component having a hydrogen reaction catalyst located in the double-walled region according to an embodiment of the present disclosure.

FIG. 13A is a schematic view of a device depicted at least partially enclosing a component that has a conduit region and a location for a hydrogen reaction catalyst according to an embodiment of the present disclosure.

FIG. 13B is an end view of the device depicted in FIG. 13A.

FIG. 13C is a cross-sectional view of the device of FIG. 13A, taken along line 13C-13C in FIG. 13B.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing from the spirit and scope of the present disclosure.

As used herein, the terms “first,” “second,” and “third” may be used interchangeably to distinguish one component from another and are not intended to signify location, order, or importance of the components.

The terms “coupled,” “attached,” “connected,” and the like, refer to both direct coupling, fixing, attaching, or connecting, as well as indirect coupling, fixing, attaching, or connecting through one or more intermediate components or features, unless otherwise specified herein.

References to an “external surface” when discussed in the context of radial directions refer to positions relative to the longitudinal centerline of the component.

The singular forms “a,” “an,” and “the” include plural references unless the context clearly dictates otherwise.

As used herein, the term “substantially completely” as used to describe a phase of the fuel refers to at least 75% by mass of the described portion of the fuel being in the stated phase, such as at least 85%, such as at least 90%, such as at least 92.5%, such as at least 95%, such as at least 97.5%, or such as at least 99% by mass of the described portion of the fuel being in the stated phase.

As used herein, a “hydrogen reaction catalyst” is a composition or a compound that catalyzes a reaction involving diatomic hydrogen as a reactant. The disclosed hydrogen reaction catalysts include a platinum group metal. In some embodiments, the hydrogen reaction catalyst is a hydrogen combustion catalyst.

As used herein, a “hydrogen combustion catalyst” is a composition or a compound that catalyzes a selective combustion reaction of diatomic hydrogen with oxygen to form water. The selective combustion reaction can be catalytic hydrogen combustion. The selectivity of the combustion reaction may be, for example, at least 50 mole %, at least 60 mole %, at least 70 mole %, at least 80 mole %, at least 90 mole %, at least 95 mole %, or at least 99 mole % of the diatomic hydrogen in the fuel including diatomic hydrogen being converted to water when the fuel including diatomic hydrogen is contacted by the hydrogen combustion catalyst in the presence of a sufficient molar amount of oxygen at operating temperature.

As used herein, the platinum group metals are ruthenium, rhodium, palladium, osmium, iridium, and platinum. In some embodiments, the hydrogen reaction catalyst includes platinum, palladium, or a combination thereof. In some embodiments, the platinum group metal is present in the form of nanoparticles. In some embodiments, the hydrogen reaction catalyst may be applied to a component in the form of a paint, a coating, a tape, an electroplated surface, a gasket, by dispersing the hydrogen reaction catalyst in penetrating oil to distribute the hydrogen reaction catalyst between mating surfaces of joints to mitigate leakage and react with any leaking hydrogen, or by deposition of dispersed hydrogen reaction catalyst using in-situ pyrolysis of organometallic platinum group metal polymers, or combinations thereof. The hydrogen reaction catalyst may include the platinum group metal on, for example, at least one supporting material chosen from a carbon support, a metal-oxide particles, a metal mesh, a ceramic support, an electroplated surface, and combinations thereof. For example, the hydrogen reaction catalyst may include a platinum group metal supported on a metal-oxide support and the hydrogen reaction catalyst may be applied to a component as, for example, a paint coating.

As used herein, objects are in “thermal contact” with each other if heat can be exchanged between the two objects. For example, a temperature sensor is in thermal contact with an object or an entity if the temperature sensor can detect a suitable temperature change that occurs in the entity, such as the hydrogen reaction catalyst, and a suitable temperature change may be, e.g., a temperature increase of ten degrees Celsius.

As used herein, a “temperature sensor” is any device that can measure an absolute temperature and/or a temperature difference. Further, a temperature sensor may include one or more instruments for measuring absolute temperatures and/or temperature differences. Some examples of temperature sensors include thermocouples, resistive temperature devices (RTDs), and the like. The temperature sensor may include one or more electrical leads for transmitting the temperature data to, e.g., a controller or other system.

As used herein, a “fuel comprising diatomic hydrogen” is a combustible composition or a compound that includes diatomic hydrogen. The fuel including diatomic hydrogen may include at least 10 weight % diatomic hydrogen, at least 20 weight % diatomic hydrogen, at least 30 weight % diatomic hydrogen, at least 40 weight % diatomic hydrogen, at least 50 weight % diatomic hydrogen, at least 60 weight % diatomic hydrogen, at least 70 weight % diatomic hydrogen, at least 80 weight % diatomic hydrogen, at least 90 weight % diatomic hydrogen, at least 95 weight % diatomic hydrogen, or at least 99 weight % diatomic hydrogen by total weight of the fuel including diatomic hydrogen. In some embodiments, the fuel including diatomic hydrogen also includes a hydrocarbon fuel, such as a jet fuel. In some embodiments, the fuel including diatomic hydrogen may exist in one or more phases such as a liquid phase, a gaseous phase, or combinations thereof. In some embodiments, the fuel including diatomic hydrogen exists in different phases in different regions of the fuel delivery system. For example, the fuel tank may contain the fuel including diatomic hydrogen as a liquid phase and the fuel system, in a downstream region, can also include the fuel including diatomic hydrogen in a gaseous phase and/or a supercritical phase. In some embodiments, the fuel including diatomic hydrogen is a hydrogen fuel.

As used here, a “reactive compound” is any compound that undergoes a reaction catalyzed by a catalyst comprising a platinum group metal in the presence of sufficient reagents and at a suitable temperature and pressure. In some embodiments, the reactive compound is a hydrocarbon, such as methane, and the catalyst is a combustion catalyst. In some embodiments, the reactive compound is diatomic hydrogen and the catalyst is a hydrogen combustion catalyst.

As used herein, a “tortuous path” is a flow path and, more specifically, a leakage path for diatomic hydrogen that includes at least one twist, bend, or turn and, preferably, multiple twists, bends, or turns.

As used herein, a “joining surface” is a surface that participates in joining one component to another. The joining surface of one component need not be in direct contact with a joining surface of the other component and may have, e.g., a hydrogen reaction catalyst positioned therebetween.

Approximating language, as used herein throughout the specification and claims, is applied to modify any quantitative representation that could permissibly vary without resulting in a change in the basic function to which it is related. Accordingly, a value modified by a term or terms, such as “about” and “substantially” is not to be limited to the precise value specified. In at least some instances, the approximating language may correspond to the precision of an instrument for measuring the value, or the precision of the methods or the machines for constructing or manufacturing the components and/or the systems. For example, the approximating language may refer to being within a one, two, four, ten, fifteen, or twenty percent margin in either individual values, range(s) of values, and/or endpoints defining range(s) of values.

Here and throughout the specification and claims, range limitations are combined and interchanged. Such ranges are identified and include all the sub-ranges contained therein unless context or language indicates otherwise. For example, all ranges disclosed herein are inclusive of the endpoints, and the endpoints are independently combinable with each other.

Fluids, such as a fuel, having diatomic hydrogen may be useful in various applications. For example, gas turbine engines may combust a fuel having diatomic hydrogen to generate a thrust, fuel-cells may consume a fuel containing diatomic hydrogen to generate a current, and fluids containing diatomic hydrogen may be useful in additional applications such as, for example, cooling. Some fuels having diatomic hydrogen may be “green” because the combustion of diatomic hydrogen produces water. In view of increasing environmental concerns relating to the production of pollutants by combusting hydrocarbons, gas turbine engines, fuel delivery systems, and aircraft that use “greener” fuels, such as some fuels including diatomic hydrogen, are needed.

To reduce carbon dioxide emissions from commercial aircraft, a fuel including diatomic hydrogen may be used. Fuels including diatomic hydrogen, however, may pose a number of challenges as compared to combustible hydrocarbon liquid fuel that does not include diatomic hydrogen. For example, fuels including diatomic hydrogen may have a relatively low boiling point, and, in a gaseous form, fuel including diatomic hydrogen can have a much lower power density. Fuels including diatomic hydrogen, when in a gaseous form, can also tend to seep through materials and attachment points between components without leaving residue. Moreover, diatomic hydrogen is colorless and odorless. When diatomic hydrogen burns, it has a flame that is not visible to the naked eye under normal lighting conditions.

Diatomic hydrogen, a highly combustible compound, may present safety risks related to the leaking and/or accumulation of diatomic hydrogen into certain locations. For example, there may be a safety risk associated with diatomic hydrogen leaking from a component of a fuel system, a fuel-cell, and/or a gas turbine engine. As such, there is a need for components, assemblies, and devices capable of detecting and/or mitigating a diatomic hydrogen leak. To solve this need, various components, assemblies, and devices are disclosed that include a hydrogen reaction catalyst. The hydrogen reaction catalyst is capable of reacting diatomic hydrogen so as to detect and/or to mitigate diatomic hydrogen that has leaked from a flow path for the fuel including diatomic hydrogen.

Disclosed herein are components, assemblies, and devices having a hydrogen reaction catalyst including a platinum group metal. Also disclosed are fuel systems, gas turbine engines, and aircraft including the disclosed components, assemblies, and devices. Further disclosed are methods of detecting and/or mitigating a diatomic fuel including a diatomic hydrogen leak by reacting the diatomic hydrogen with a hydrogen reaction catalyst.

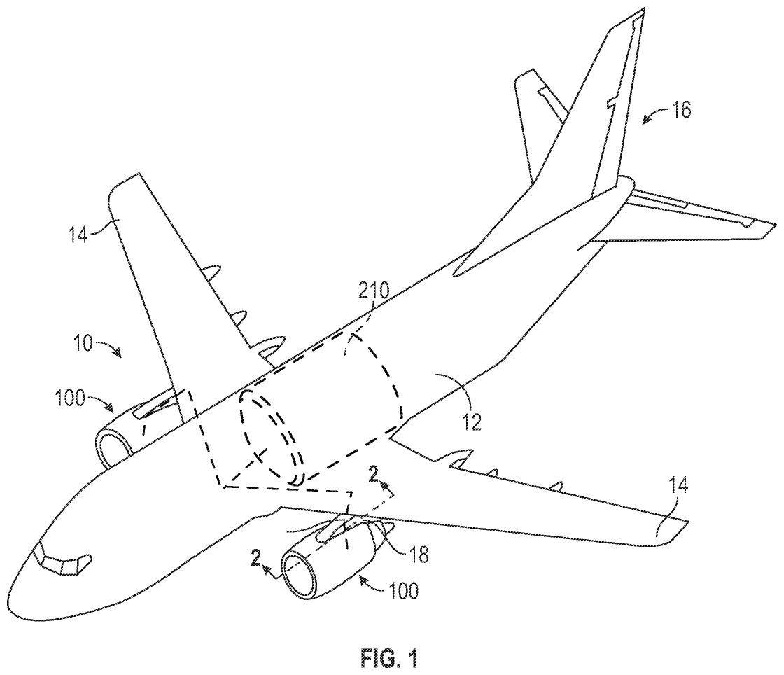

FIG. 1 is a schematic view of an aircraft 10 that may implement some embodiments of the disclosure. The aircraft 10 includes a fuselage 12, a pair of wings 14 attached to the fuselage 12, and an empennage 16. The aircraft 10 also includes a propulsion system that produces a propulsive thrust to propel the aircraft 10 in flight, during taxiing operations, and the like. The propulsion system for the aircraft 10 shown in FIG. 1 includes a pair of engines 100. In this embodiment, each engine 100 is attached to one of the wings 14 by a pylon 18 in an under-wing configuration. Although the engines 100 are shown attached to the wing 14 in an under-wing configuration in FIG. 1, in other embodiments, the engine 100 may have alternative configurations and be coupled to other portions of the aircraft 10. For example, the engine 100 may additionally or alternatively include one or more aspects coupled to other parts of the aircraft 10, such as, for example, the empennage 16 and the fuselage 12.

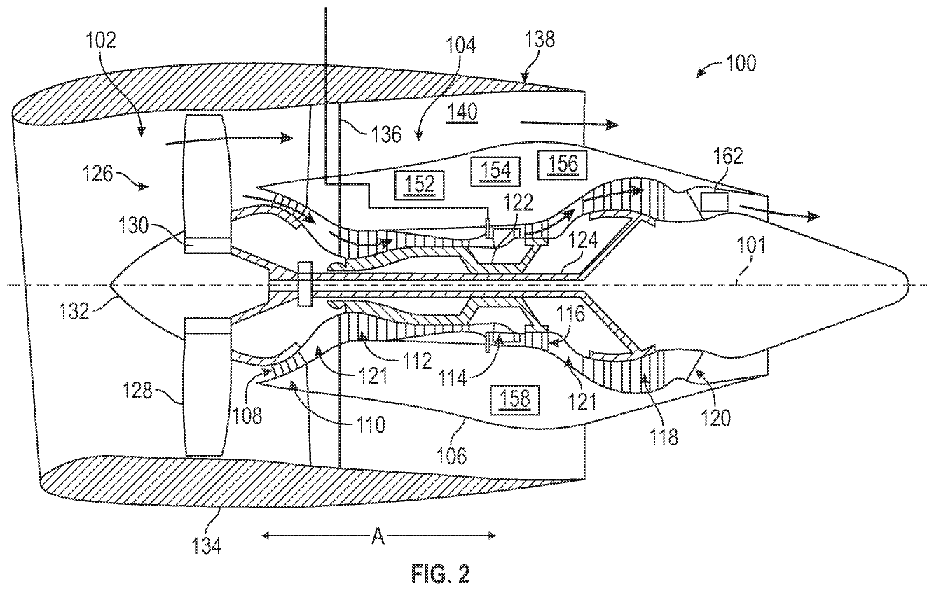

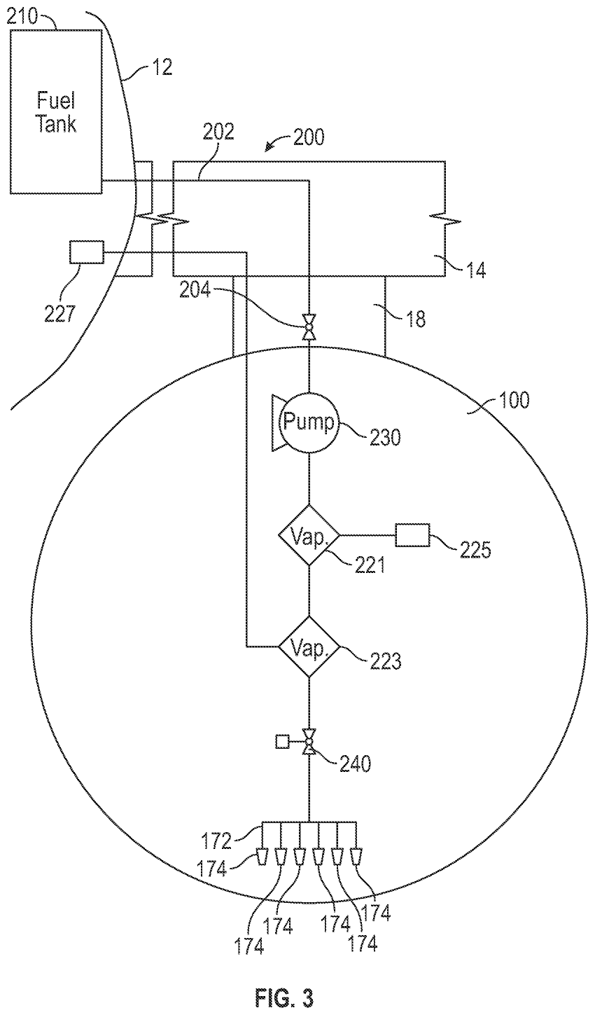

As will be described further below with reference to FIG. 2, the engines 100 shown in FIG. 1 are gas turbine engines that are each capable of selectively generating a propulsive thrust for the aircraft 10. The amount of propulsive thrust may be controlled at least in part based on a volume of fuel provided to the gas turbine engines 100 via a fuel system 200 (see FIG. 3). In some embodiments, the fuel is a fuel including diatomic hydrogen that is stored in a fuel tank 210 of the fuel system 200. As shown in FIG. 1, at least a portion of the fuel tank 210 is located in the fuselage 12 and, in this embodiment, entirely within the fuselage 12. The fuel tank 210, however, may be located at other suitable locations in the fuselage 12 or the wing 14, such as with a portion of the fuel tank 210 in the fuselage 12 and a portion of the fuel tank 210 in the wing 14. Alternatively, the fuel tank 210 may also be located entirely within the wing 14. In some embodiments, the fuel tank 210 may be located away from the wing center of lift and the moment is accounted for by different means (e.g., trim). In the embodiment shown in FIG. 1, a single fuel tank 210 is used, and the fuel tank 210 is located within the fuselage 12 such that, relative to the forward direction and the aft direction, the fuel tank 210 is located at the wing center of lift. Any suitable number of fuel tanks 210 may be used, however, including a plurality of fuel tanks 210. The plurality of fuel tanks 210 may include, for example, a forward fuel tank and an aft fuel tank. The forward fuel tank and the aft fuel tank may be located in the fuselage 12 and balanced about the wing center of lift to promote the stability of the aircraft 10 during flight. In another embodiment, the plurality of fuel tanks 210 may include two separate tanks each located within a corresponding wing 14.

Although the aircraft 10 shown in FIG. 1 is an airplane, the embodiments described herein may also be applicable to other aircraft 10, including, for example, helicopters and unmanned aerial vehicles (UAV). The aircraft discussed herein are, e.g., fixed-wing aircraft or rotor aircraft that generate lift by aerodynamic forces acting on, for example, a fixed wing (e.g., wing 14) or a rotary wing (e.g., rotor of a helicopter), and are, e.g., heavier-than-air aircraft, as opposed to lighter-than-air aircraft (such as a dirigible). In addition, the embodiments described herein may also be applicable to other applications where fuels including diatomic hydrogen can be used. The engines described herein are gas turbine engines, but the embodiments described herein also may be applicable to other engines. Further, the engine, specifically, the gas turbine engine, is an example of a power generator using fuel including diatomic hydrogen, but fuel including diatomic hydrogen may be used for other power generators, including, for example, fuel cells. Such power generators may be used in various applications including stationary power-generation systems (including both gas turbines and fuel including diatomic hydrogen cells) and other vehicles beyond the aircraft 10 explicitly described herein, such as boats, ships, cars, trucks, and the like.

FIG. 2 is a schematic, cross-sectional view of one of the engines 100 used in the propulsion system for the aircraft 10 shown in FIG. 1. The engine 100 shown in FIG. 2 is a high-bypass turbofan engine. The engine 100 may also be referred to as a turbofan engine 100 herein. The turbofan engine 100 has an axial direction A (extending parallel to a longitudinal centerline 101, shown for reference in FIG. 2) and a circumferential direction. The circumferential direction (not depicted in FIG. 2) extends in a direction rotating about the axial direction A. The turbofan engine 100 includes a fan section 102 and a turbomachine 104 disposed downstream from the fan section 102.

The turbomachine 104 depicted in FIG. 2 includes a tubular outer casing 106 (housing or nacelle) that defines an annular inlet 108. The outer casing 106 encases, in a serial flow relationship, a compressor section including a booster or a low-pressure (LP) compressor 110 and a high-pressure (HP) compressor 112, a combustion section 114, a turbine section including a high-pressure (HP) turbine 116 and a low-pressure (LP) turbine 118, and a jet exhaust nozzle section 120. The compressor section, the combustion section 114, and the turbine section together define at least in part a central air flow path 121 extending from the annular inlet 108 to the jet exhaust nozzle section 120. In some embodiments, the turbofan engine further includes one or more drive shafts. More specifically, in some embodiments, the turbofan engine includes a high-pressure (HP) shaft or spool 122 drivingly connecting the HP turbine 116 to the HP compressor 112, and a low-pressure (LP) shaft or a spool 124 drivingly connecting the LP turbine 118 to the LP compressor 110.

The fan section 102 shown in FIG. 2 includes a fan 126 having a plurality of fan blades 128 coupled to a disk 130 spaced apart in a circumferential direction around the disk 130. The fan blades 128 and the disk 130 are rotatable, together, about the longitudinal centerline (axis) 101 by the LP shaft 124. In some embodiments, the disk 130 is covered by a rotatable front hub 132 aerodynamically contoured to promote an airflow through the plurality of fan blades 128. Further, in some embodiments, an annular fan casing or an outer nacelle 134, circumferentially surrounds the fan 126 and/or at least a portion of the turbomachine 104. A plurality of circumferentially spaced outlet guide vanes 136 supports the nacelle 134 relative to the turbomachine 104. A downstream section 138 of the nacelle 134 extends over an outer portion of the turbomachine 104 so as to define a bypass airflow passage 140 therebetween.

The turbofan engine 100 is operable with the fuel system 200 (FIG. 3) and receives a flow of fuel from the fuel system 200. As will be described further below, the fuel system 200 includes a fuel delivery assembly 202 (FIG. 3) providing the fuel flow from the fuel tank 210 (FIG. 1) to the engine 100, and, more specifically, to a fuel manifold 172 (not labeled in FIG. 2, see FIG. 3) of the combustion section 114 of the turbomachine 104 of the turbofan engine 100.

The turbofan engine 100 also includes various accessory systems to aid in the operation of the turbofan engine 100 and/or an aircraft including the turbofan engine 100. For example, the turbofan engine 100 may include a main lubrication system 152, a compressor cooling air (CCA) system 154, an active thermal clearance control (ATCC) system 156, and a generator lubrication system 158, each of which is depicted schematically in FIG. 2. The main lubrication system 152 is configured to provide a lubricant to, for example, various bearings and gear meshes in the compressor section, the turbine section, the HP spool 122, and the LP shaft 124. The lubricant provided by the main lubrication system 152 may increase the useful life of such components and may remove a certain amount of heat from such components. The compressor cooling air (CCA) system 154 provides air from one or both of the HP compressor 112 or the LP compressor 110 to one or both of the HP turbine 116 or the LP turbine 118. The ATCC system 156 cools a casing of the turbine section to maintain a clearance between the various turbine rotor blades and the turbine casing within a desired range throughout various engine operating conditions. The generator lubrication system 158 provides lubrication to an electronic generator (not shown), as well as cooling/heat removal for the electronic generator. The electronic generator may provide electrical power to, for example, a start-up electrical motor for the turbofan engine 100 and/or various other electronic components of the turbofan engine 100 and/or an aircraft including the turbofan engine 100.

Heat from these accessory systems 152, 154, 156, 158, and other accessory systems may be provided to various heat sinks as waste heat from the turbofan engine 100 during operation, such as to various vaporizers 221, 223, as discussed below with regard to FIG. 3. Additionally, the turbofan engine 100 may include one or more heat exchangers 162 within, for example, the central air flow path 121, such as the turbine section or the jet exhaust nozzle section 120. Such heat exchangers 162 may be used to extract waste heat from an airflow therethrough also to provide heat to various heat sinks, such as the vaporizers 221, 223, discussed below.

The turbofan engine 100 discussed herein is provided by way of example only. In other embodiments, any other suitable engine may be utilized with aspects of the present disclosure. For example, in other embodiments, the engine may be any other suitable gas turbine engine, such as a turboshaft engine, a turboprop engine, a turbojet engine, and the like. Still further, in other embodiments, the gas turbine engine may have other suitable configurations, such as other suitable numbers or arrangements of shafts, compressors, turbines, fans, etc. Further, although the turbofan engine 100 is shown as a direct drive, fixed-pitch turbofan engine 100, in other embodiments, a gas turbine engine may be a geared gas turbine engine (i.e., including a gearbox between the fan 126 and the shaft driving the fan, such as the LP shaft 124), or a variable pitch gas turbine engine (i.e., including a fan 126 having a plurality of fan blades 128 rotatable about their respective pitch axes), etc. Further, still, in alternative embodiments, aspects of the present disclosure may be incorporated into, or otherwise utilized with, any other type of engine, such as reciprocating engines, as discussed above. Additionally, in still other exemplary embodiments, the exemplary turbofan engine 100 may include or be operably connected to any other suitable accessory systems. Additionally, or alternatively, the exemplary turbofan engine 100 may not include or be operably connected to one or more of the accessory systems 152, 154, 156, 158, and 162, discussed above.

FIG. 3 is a schematic view of the fuel system 200 according to an embodiment of the present disclosure. The fuel system 200 is configured to store the fuel including diatomic hydrogen for the engine 100 in the fuel tank 210 and to deliver the fuel including diatomic hydrogen to the engine 100 via a fuel delivery assembly 202. The fuel delivery assembly 202 includes tubes, pipes, conduits, and the like, to fluidly connect the various components of the fuel system 200 to the engine 100. The fuel tank 210 may be configured to hold the fuel including diatomic hydrogen at least partially within the liquid phase and may be configured to provide fuel including diatomic hydrogen to the fuel delivery assembly 202 substantially completely in the liquid phase, such as completely in the liquid phase. For example, the fuel tank 210 may have a fixed volume and contain a volume of the fuel including diatomic hydrogen in the liquid phase. As the fuel tank 210 provides fuel including diatomic hydrogen to the fuel delivery assembly 202 substantially completely in the liquid phase, the volume of the liquid fuel including diatomic hydrogen in the fuel tank 210 decreases and the remaining volume in the fuel tank 210 is made up by, for example, diatomic hydrogen in a gaseous phase. Alternatively, in some embodiments, the fuel tank 210 may be configured to hold the fuel including diatomic hydrogen at least partially within the supercritical phase and may be configured to provide fuel including diatomic hydrogen to the fuel delivery assembly 202 substantially completely in the supercritical phase, such as completely in the supercritical phase.

To store the fuel including diatomic hydrogen substantially completely in the liquid phase, the fuel including diatomic hydrogen may be stored in the fuel tank 210 at very low (cryogenic) temperatures. For example, the fuel including diatomic hydrogen may be stored in the fuel tank 210 at about negative two hundred fifty-three degrees Celsius or less at atmospheric pressure, or at other temperatures and pressures to maintain the fuel including diatomic hydrogen substantially in the liquid phase. The fuel tank 210 may be a double-walled cryogenic storage tank made from known materials such as titanium, Inconel®, aluminum, or composite materials. In some embodiments, a vacuum may be drawn in a cavity of the double-walled tank as a means reducing heat transfer and keeping the fuel including diatomic hydrogen in the fuel tank 210 cold. The fuel tank 210 and the fuel system 200 may include a variety of supporting structures and components to facilitate storing the fuel including diatomic hydrogen in such a manner.

The liquid fuel including diatomic hydrogen may be supplied from the fuel tank 210 to the fuel delivery assembly 202. The fuel delivery assembly 202 includes tubes, pipes, conduits, and the like, configured to carry the fuel including diatomic hydrogen between the fuel tank 210 and the engine 100. The fuel delivery assembly 202 provides a flow path of the fuel including diatomic hydrogen from the fuel tank 210 downstream to the engine 100. The fuel delivery assembly 202 may also include various valves (for example, shut-off valve 204) and other components to deliver the fuel including diatomic hydrogen to the engine 100 that are not shown in FIG. 3. The fluid lines discussed herein, particularly, those conveying liquid hydrogen, may be vacuum jacketed pipes.

The fuel tank 210 in this embodiment contains a fuel including diatomic hydrogen source, and the fuel delivery assembly 202 is configured to receive fuel including diatomic hydrogen from the fuel tank 210 (fuel including diatomic hydrogen source) and to provide the fuel including diatomic hydrogen from the fuel including diatomic hydrogen source to the engine 100 (power generator), and, more specifically, a fuel input array (e.g., the fuel manifold 172 and the fuel nozzles 174, discussed further below) of the engine 100. The fuel system 200 may include a shut-off valve 204, positioned, for example, in the pylon 18, the wings 14, the fuselage 12, or at another position between the fuel tank 210 and the engine 100 that can be used to isolate and to disconnect the fuel tank 210 from the components of the fuel delivery assembly 202 that are downstream of the shut-off valve 204. The shut-off valve 204 may, thus, be positioned to isolate the components of the fuel system 200 that are located in the engine 100 from the components of the fuel system 200 located in the remaining portion of the aircraft 10 (FIG. 1).

The fuel including diatomic hydrogen is delivered to the engine 100 by the fuel delivery assembly 202 in a liquid phase, a gaseous phase, a supercritical phase, or both of a gaseous phase and a supercritical phase. The fuel system 200, thus, includes at least one vaporizer 221, 223 in fluid communication with the fuel delivery assembly 202 to heat the liquid or supercritical fuel including diatomic hydrogen flowing through the fuel delivery assembly 202. In the embodiment shown in FIG. 3, the fuel system 200 includes two vaporizers, a main vaporizer 221 and a secondary vaporizer 223. Each vaporizer 221, 223 is positioned in the flow path of the fuel including diatomic hydrogen between the fuel tank 210 and the engine 100. In the embodiment shown in FIG. 3, each vaporizer 221, 223 is positioned at least partially within the engine 100. When positioned in the engine 100, the vaporizers 221, 223 may be located in the nacelle 134 (FIG. 2), for example. The vaporizers 221, 223 may, however, be positioned at other suitable locations in the flow path of the hydrogen between fuel tank 210 and the engine 100. For example, the vaporizers 221, 223 may be positioned external to the engine 100 and positioned in the fuselage 12, the wing 14, or the pylon 18.

Each vaporizer 221, 223 is in thermal communication with at least one heat source, such as a primary heat source 225, a secondary heat source 227, or both. In this embodiment, the primary vaporizer 221 is configured to operate once the engine 100 is in a thermally stable condition and the primary heat source 225 is waste heat from the engine 100. The main vaporizer 221 is, thus, thermally connected to at least one of the main lubrication system 152 (FIG. 2), the compressor cooling air system 154 (FIG. 2), the active thermal clearance control system 156 (FIG. 2), the generator lubrication system 158 (FIG. 2), or the heat exchangers 162 (FIG. 2) to extract waste heat from the engine 100 to heat the fuel including diatomic hydrogen. In such a manner, the vaporizer 221 is configured to operate by drawing heat from the primary heat source 225 once the engine 100 is capable of providing enough heat, via the primary heat source 225, to the vaporizer 221, in order to facilitate operation of the vaporizer 221.

The secondary vaporizer 223 of some embodiments is a combination start-up and trim vaporizer that may be used to heat the liquid fuel including diatomic hydrogen flowing through the fuel delivery assembly 202 when the main vaporizer 221 is not sufficient to heat the fuel including diatomic hydrogen. During start-up of the engine 100, for example, the engine 100 may not be in a thermally stable condition, and the secondary vaporizer 223 is used during start-up (or prior to start-up) to heat the fuel including diatomic hydrogen instead of the main vaporizer 221. In this example, the secondary vaporizer 223 operates as a start-up vaporizer. In another example, the main vaporizer 221 may not be heating the fuel including diatomic hydrogen to the desired temperature and, thus, the secondary vaporizer 223 operates as a trim vaporizer to add supplemental heat to the fuel including diatomic hydrogen and to heat the fuel including diatomic hydrogen to the desired temperature. Such a condition may occur when, for example, the heat provided by the primary heat source 225 to the main vaporizer 221 is not sufficient to heat the fuel including diatomic hydrogen to the desired temperature.

The secondary vaporizer 223 is thermally coupled to the secondary heat source 227. With the secondary vaporizer 223 operating as a combination start-up and trim vaporizer, the secondary heat source 227 is preferably a heat source external to the engine 100 that may provide heat for the secondary vaporizer 223 independent of whether or not the engine 100 is running and can be used, for example, during start-up (or prior to start-up) of the engine 100. The secondary heat source 227 may include, for example, an electrical power source, a catalytic heater or burner, and/or a bleed airflow from an auxiliary power unit. The secondary heat source 227 may be integral to the secondary vaporizer 223, such as when the secondary vaporizer 223 includes one or more electrical resistance heaters, or the like, that are powered by the electrical power source.

As noted above, the vaporizers 221, 223 may be thermally coupled to any suitable heat source. For example, the main vaporizer 221 and/or the secondary vaporizer 223 may be thermally coupled to both waste heat from the engine 100 and a heat source external to the engine 100. In the embodiment shown in FIG. 3, the main vaporizer 221 and the secondary vaporizer 223 are located in series relative to the flow of hydrogen in the fuel delivery assembly 202, with the secondary vaporizer 223 being downstream from the main vaporizer 221. Other arrangements of the vaporizers 221, 223 may be used, however, such as the main vaporizer 221 and the secondary vaporizer 223 being arranged in parallel to each other.

The fuel system 200 includes multiple components that are joined together at joints to provide a flow path to deliver the fuel including diatomic hydrogen from the fuel tank 210 to the power generator and, more specifically, the combustion section 114 (FIG. 2). Each of the components of the fuel system 200 may include a conduit region, having a flow path to convey a fuel including diatomic hydrogen, and a connector region to connect the component to another component. The two components may form an assembly and may be joined together with the corresponding connector regions, forming a joint. More specifically, the connector region of each component may be used to fluidly connect the conduit region and flow path of the component with conduit region and the flow path of the other component to form a continuous flow path for the fuel including diatomic hydrogen to follow through the assembly and joint. The joint may be susceptible to the diatomic hydrogen leaking through a leakage path of the joint. The joint and/or at least one of the components forming the joint includes a hydrogen reaction catalyst for detecting and/or mitigating diatomic hydrogen if the diatomic hydrogen leaks from a flow path for the fuel including diatomic hydrogen. Thus, the components of the fuel system 200 may include a hydrogen reaction catalyst including a platinum group metal. In some embodiments, the component is an aircraft component. For example, the component may be located along a flow path connecting the fuel tank 210 to a pump 230, a heat exchanger 162 (FIG. 2), a metering valve 240, a bypass valve, a shutoff valve 204, an accumulator, a venting structure, a fuel nozzle 174, a fuel manifold 172, a vaporizer 221/223, or a fuel injector. Further, for example, the component may form a portion of a pump 230, a heat exchanger 162, a metering valve 240, a bypass valve, a shutoff valve 204, an accumulator, a venting structure, a fuel nozzle 174, a fuel manifold 172, a vaporizer 221/223, or a fuel injector in an aircraft. In some embodiments, each of the secondary heat source 227, the pump 230, the vaporizer 221/223, the primary heat source 225, 223, and the metering valve 240 can be independently positioned in the fuselage 12, the wings 14, the pylon 18, or an engine compartment.

The disclosed components can be joined with other components to form various assemblies. These components and assemblies can be incorporated into aircraft, fuel systems, and/or gas turbine engines such as those disclosed herein. In some embodiments, the fuel system is an aircraft fuel system, but these components and assemblies may be used in other systems conveying diatomic hydrogen, including fuel, such as, for example, a standalone system for providing fuel to a vehicle or aircraft. In some embodiments, the disclosed components and assemblies are useful for detecting and/or mitigating a diatomic hydrogen leak if the diatomic hydrogen leaks from the flow path in the conduit region.

In some embodiments, the conduit region may be a portion of a tube or a pipe. Components can be joined to other components at a connector region. For example, the connection region, may include a joining surface to fluidly connect the conduit region of the first component to a conduit region in another component. In some embodiments, the connector region also includes an external surface such as the outer cylindrical surface of a flange-type connector. Some examples of connectors include flange connectors, barb connectors, bayonet connectors, threaded connectors, swage-lock connectors, v-band connectors, welded connections, soldered connections, brazed connections, and combinations thereof.

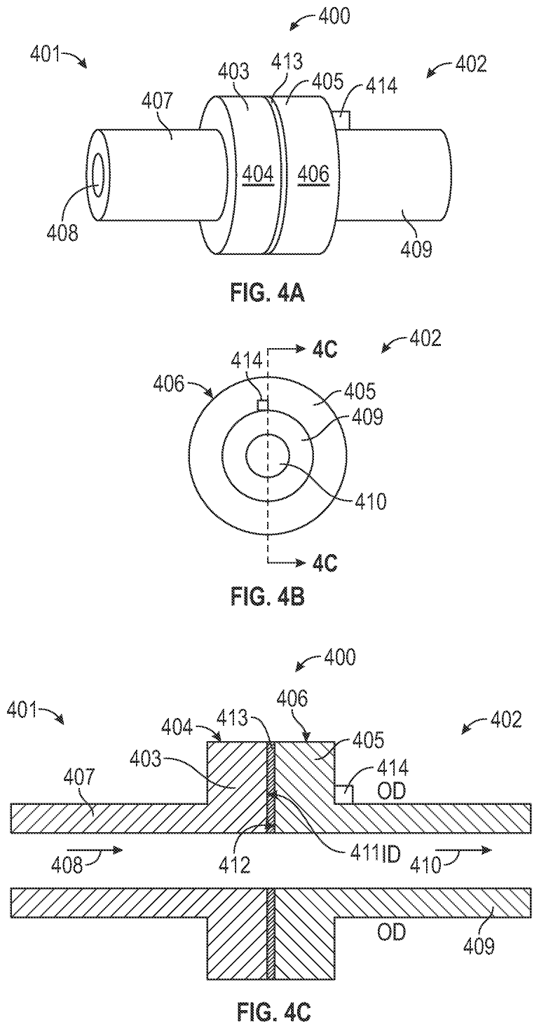

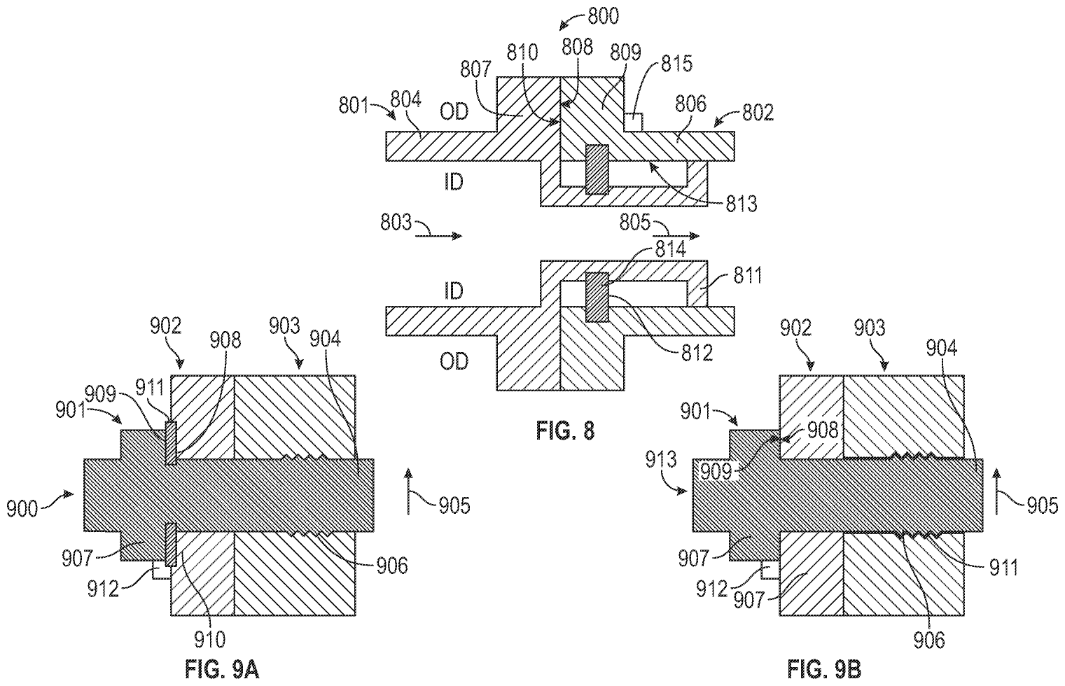

FIGS. 4A to 12 depict some examples of components and assemblies that can be incorporated into an aircraft, a fuel system, and/or a gas turbine engine for detecting and/or mitigating a diatomic hydrogen leak. Although described as different embodiments, the features described with reference to one assembly may be combined with features of another assembly. For example, when the flanges shown in FIGS. 4A to 4E are joined by bolts, the bolts (third component 1003) and position of the hydrogen reaction catalyst 1012 shown in FIG. 10 may be used. Moreover, the same reference numerals will be used for components and features of FIGS. 4A to 12 that are the same as or similar in each of these components and assemblies. The description of these similar components and features apply to each of the embodiments of FIGS. 4A to 12 and a detailed description of components and features is therefore not repeated.

FIG. 4A is a schematic view of a first flange assembly 400 according to an embodiment of the disclosure. FIG. 4B is an end view of the first flange assembly 400 shown in FIG. 4A taken in the direction of line 4G-4G shown in FIG. 4F, and FIG. 4C is a cross-sectional view of the first flange assembly 400 shown in FIG. 4B, taken along line 4C-4C in FIG. 4B. The first flange assembly 400 includes a first component 401 and a second component 402 that are joined together. The first component 401, the second component 402, and the depicted first flange assembly 400 may be, for example, components and assemblies of the gas turbine engine 100 (FIG. 2) and, more specifically, components and assemblies of the fuel system 200 (FIG. 3) discussed above.

The first component 401 and the second component 402 are joined together by a connector, which, in the depicted embodiment, is a flange. The first component 401 has a flange-type connector region 403 including an external surface 404 and the second component 402 also includes a flange-type connector region 405 including an external surface 406. The flange-type connector region 403 of the first component 401 is joined to the flange-type connector region 405 of the second component 402, forming a joint. The flanges can be attached to each other by conventional means including, e.g., bolts, welding, or the like.

The first component 401 also includes a conduit region 407 with a flow path 408 for conveying a fuel including diatomic hydrogen, and, similarly, the second component 402 includes a conduit region 409 with a flow path 410 for conveying a fuel including diatomic hydrogen. The first component 401 may be connected to the second component 402 to fluidly connect the flow path 408 of the first component 401 with the flow path 410 of the second component 402, forming a continuous flow path for the fuel including diatomic hydrogen to follow through the first flange assembly 400. The flange-type connector region 403 of the first component 401 includes a joining surface 411, and, similarly, the flange-type connector region 405 of the second component 402 includes a joining surface 412. The joining surface 411 of the first component 401 may be transverse to the flow path 408 of the first component 401, and as depicted, the joining surface 411 is perpendicular to the flow path 408. Similarly, the joining surface 412 of the second component 402 may be transverse to the flow path 410 of the second component 402, and as depicted, the joining surface 412 is perpendicular to the flow path 410.

When the first component 401 and the second component 402 are joined together, the joining surface 411 of the first component 401 is positioned to oppose the joining surface 412 of the second component 402, but even if the joining surface 411 of the first component 401 abuts the joining surface 412 of the second component 402, the diatomic hydrogen may leak between the joining surface 411 and the joining surface 412, forming a hydrogen leakage path. In some embodiments, the leakage path has a cross-sectional area much less than the cross-sectional area of the flow path 408 and/or the flow path 410. For example, the leakage path may have a cross-sectional area less than 0.001 times the cross-sectional area of the flow path 408 and/or the flow path 410, than 0.0001 times the cross-sectional area of the flow path 408 and/or the flow path 410, or than 0.00001 times the cross-sectional area of the flow path 408 and/or the flow path 410. The first flange assembly 400 includes a hydrogen reaction catalyst 413 located at the leakage path between the joining surface 411 of the first component 401 and the joining surface 412 of the second component 402 to react diatomic hydrogen if the diatomic hydrogen leaks from the flow path 408. More specifically, in this embodiment, the hydrogen reaction catalyst 413 is sandwiched between the joining surface 411 of the first component 401 and the joining surface 412 of the second component 402.

The hydrogen reaction catalyst 413 may be positioned between the joining surface 411 of the first component 401 and the joining surface 412 of the second component 402 by any of the suitable means discussed above. For example, the hydrogen reaction catalyst 413 may be a separate component, such as, for example, a washer or a gasket, or the hydrogen reaction catalyst 413 may be formed integrally on at least one of the joining surface 411 of the first component 401 or joining surface 412 of the second component 402 by, for example, electroplating, by dispersing the hydrogen reaction catalyst 413 in penetrating oil to distribute the hydrogen reaction catalyst between mating surfaces of joints to mitigate leakage and react with any leaking hydrogen, or by deposition of dispersed hydrogen reaction catalyst 413 using in-situ pyrolysis of organometallic platinum group metal polymers.

The hydrogen reaction catalyst 413 is positioned to react with hydrogen leaking from the flow path of the hydrogen, e.g., the flow path 408 and the flow path 410, through the first component 401 and the second component 402, respectively. Preferably, however, the hydrogen reaction catalyst 413 does not react with, or otherwise impede the flow of hydrogen through the first component 401 and the second component 402, and the flow path 408 and the flow path 410 are free of the hydrogen reaction catalyst so as not to react diatomic hydrogen within the flow path 408 and the flow path 410 (i.e., that diatomic hydrogen has not escaped). Similarly, flow paths of all of the embodiments discussed below are free of the hydrogen reaction catalyst so as not to react diatomic hydrogen that has not escaped the flow path.

As discussed further below, a temperature sensor may be provided for use in methods of detecting leaking diatomic hydrogen. As shown in FIGS. 4A-4C, for example, a temperature sensor 414 is in thermal contact with the hydrogen reaction catalyst for detecting an increase in temperature caused by reaction of the leaking diatomic hydrogen by the hydrogen reaction catalyst 413. The temperature sensor 414 may be, for example, attached to an external surface of the flange-type connector region 405 of the second component 402, and, as heat is generated by the reaction catalyst, the heat is transferred though the flange-type connector region 405 and detected by the temperature sensor 414.

FIG. 4D is cross-sectional view of a second flange assembly 415 according to another embodiment of the disclosure. The second flange assembly 415 differs from the first flange assembly 400 in that the flange-type connector region 403 of the first component 401 is received by the second component 402 at the flange-type connector region 405. The flange-type connector region 405 of the second component 402 thus includes an overhang region 416 and the joining surface 412 of the flange-type connector region 405 includes an internal surface 417 of the overhang region 416. The internal surface 417 faces the external surface 404 of the flange-type connector region 403 of the first component 401. When the flange-type connector region 403 of the first component 401 is received by the second component 402 in this manner, joining surface 411 of the first component 401 also includes the external surface 404 of the flange-type connector region 403 of the first component 401, in this embodiment. As noted above, the hydrogen reaction catalyst 413 may be positioned between the joining surface 411 of the first component 401 and the joining surface 412 of the second component, and, more specifically, in the embodiment shown in FIG. 4D, between internal surface 417 of the overhang region 416 and the external surface 404 of the first component 401. Thus, the hydrogen reaction catalyst 413 is disposed on a portion of the joining surface 411 that extends parallel to the flow path 408 to react diatomic hydrogen if the diatomic hydrogen leaks from the flow path 408.

FIG. 4E is a cross-sectional view of a third flange assembly 418 according to another embodiment of the disclosure. The third flange assembly 418 differs from the first flange assembly 400 in that the hydrogen reaction catalyst 413 is positioned on the external surface 404 of the first component 401 and the external surface 406 of the second component 402 to react diatomic hydrogen if it leaks from the flow path 408. As depicted in FIG. 4E, the hydrogen reaction catalyst 413 circumscribes the flange-type connector region 403 of the first component 401 and the flange-type connector region 405 of the second component 402 and, more specifically, the joining surface 411 of the first component 401 and the joining surface 412 of the second component 402.

FIG. 4F is a schematic view of a fourth flange assembly 419 according to an embodiment of the disclosure. FIG. 4G is an end view of the fourth flange assembly 419 shown in FIG. 4F viewed along 4G-4G. FIGS. 4F and 4G depict an embodiment where the temperature sensor (e.g., temperature sensor 414 of FIGS. 4A-4E) is a ring-shaped temperature sensor 420 positioned in thermal contact with the hydrogen reaction catalyst 413 for detecting an increase in temperature caused by reaction of the leaking diatomic hydrogen by the hydrogen reaction catalyst 413. The ring-shaped temperature sensor 420 may be, for example, attached to an external surface of the flange-type connector region 405 of the second component 402. For example, the ring-shaped temperature sensor 420 may be in continuous contact with the flange-type connector region 405 along the entire outer edge of a side face of the ring-shaped temperature sensor 420. The ring-shaped temperature sensor 420 may be circumferentially in contact with the flange-type connector region 405, such as for one rotation (i.e., for three-hundred sixty degrees). This continuous contact may improve the thermal contact between the ring-shaped temperature sensor 420 and the hydrogen reaction catalyst 413. As heat is generated by the hydrogen reaction catalyst 413, the heat is transferred though the flange-type connector region 405 and detected by the ring-shaped temperature sensor 420.

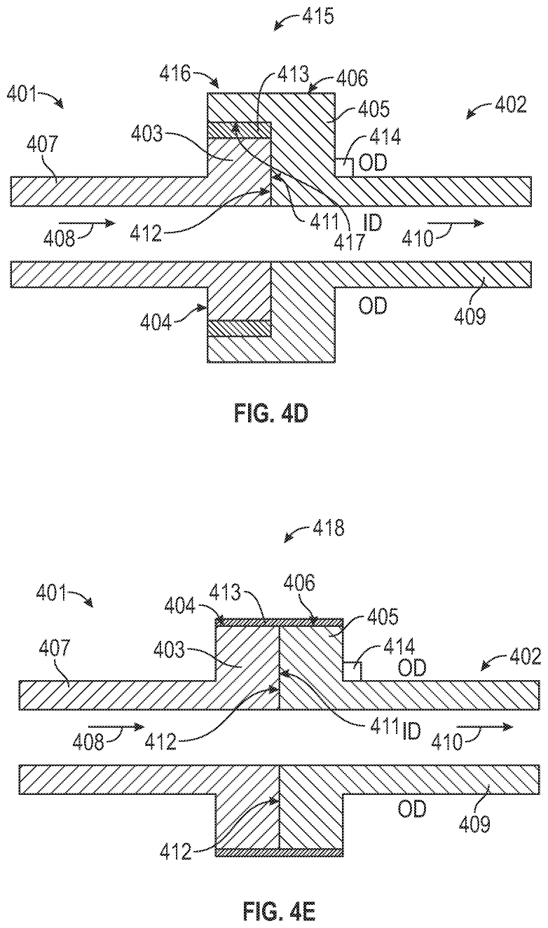

FIG. 5A depicts cross-sectional view of an enclosed volume assembly 500 of a first component 501 and a second component 502. The first component 501 includes a conduit region 503 with a flow path 504 for conveying a fuel including diatomic hydrogen, and, similarly, the second component 502 includes a conduit region 505 with a flow path 506 for conveying a fuel including diatomic hydrogen. The first component 501 may be connected to the second component 502 to fluidly connect the flow path 504 of the first component 501 with the flow path 506 of the second component 502 forming a continuous flow path for the fuel including diatomic hydrogen to flow through the enclosed volume assembly 500. As with the first component 401 and second component 402 discussed above, each of the first component 501 and the second component 502 include a connector region, which in the depicted embodiment, is a flange (i.e., a flange-type connector region 507 and a flange-type connector region 508, respectively). The flange-type connector region 507 of the first component 501 includes a joining surface 509, and, similarly, the flange-type connector region 508 of the second component 502 includes a joining surface 510.

When the first component 501 and the second component 502 are joined together, the joining surface 509 of the first component 501 is positioned to oppose the joining surface 510 of the second component 502, but even if the joining surface 509 of the first component 501 abuts the joining surface 510 of the second component 502, the diatomic hydrogen may leak between the joining surface 509 and the joining surface 510, forming a hydrogen leakage path. At least one of the joining surface 509 of the first component 501 or the joining surface 510 of the second component 502 includes a recess to form an enclosed volume 511 in conjunction with the joining surface 509 or the joining surface 510, along the hydrogen leak path. In the depicted embodiment, both the joining surface 509 of the first component 501 and the joining surface 510 of the second component 502 include opposing recess 512 and recess 513, respectively, to form the enclosed volume 511. The enclosed volume assembly 500 depicted in FIG. 5A includes a hydrogen reaction catalyst 514 located in the enclosed volume 511 at the leakage path between the joining surface 509 of the first component 501 and the joining surface 510 of the second component 502 to react diatomic hydrogen if it leaks from the flow path 504 and the flow path 506.

The hydrogen reaction catalyst 514 may be positioned in the enclosed volume 511 by various suitable means such as those discussed above. In some embodiments, the hydrogen reaction catalyst 514 may be applied or otherwise positioned on the surfaces forming the recess 512 and recess 513. For example, in this embodiment, the recess 512 on the joining surface 509 of the first component 501 and the recess 513 on the joining surface 510 of the second component 502 may be used to enclose a seal. Suitable seals include, for example, O-rings, C-seals, W/E-seals, D-seals, omega seals, and the like. The seal may include the hydrogen reaction catalyst 514, such as, by the hydrogen reaction catalyst 514 being applied to a surface of the seal.

In some embodiments, a temperature sensor 515 is in thermal contact with the hydrogen reaction catalyst 514 for detecting an increase in temperature caused by reaction of the leaking diatomic hydrogen by the hydrogen reaction catalyst 514 in a manner similar to temperature sensor 414 discussed herein.

FIG. 5B depicts an enclosed tortuous path assembly 516. Unlike the enclosed volume assembly 500 of FIG. 5A, in the embodiment depicted in FIG. 5B, only one of the two components (here, the second component 502) has a recess 513 on its joining surface 510 to form the enclosed volume 511. The enclosed volume 511 of the enclosed tortuous path assembly 516 is further depicted in FIG. 5C.

FIG. 5C is a detail view showing a tortuous path 517 within the enclosed volume 511 of the enclosed tortuous path assembly 516. Specifically, FIG. 5C shows detail 5C of FIG. 5B. The tortuous path 517 includes multiple turns so as to increase the available surface area for contacting leaked diatomic hydrogen. The tortuous path 517 may be formed with, for example, a series of interspaced walls, each of which faces the enclosed volume 511 on at least two sides of the wall. For example, the tortuous path 517 may include one wall that faces the enclosed volume 511 on two sides, two walls, each of which face the enclosed volume 511 on two sides, or three or more walls, each of which face the enclosed volume 511 on two sides. The tortuous path 517 depicted in FIG. 5C has three interspaced walls and each wall faces the enclosed volume 511 on two sides. A hydrogen reaction catalyst 514 is located in the enclosed volume 511 on the walls of the tortuous path 517 at the leakage path between the joining surface 509 of the first component 501 and the joining surface 510 of the second component 502 to react diatomic hydrogen if the diatomic hydrogen leaks from the flow path 504 (FIG. 5B) and the flow path 506 (FIG. 5B). As discussed above, the hydrogen reaction catalyst 514 may be positioned in the enclosed volume 511 on the walls of the tortuous path 517 by various suitable means discussed above such as, for example, as a coating, as an electroplated surface, as a paint, by dispersing the hydrogen reaction catalyst 413 in penetrating oil to distribute the hydrogen reaction catalyst between mating surfaces of joints to mitigate leakage and react with any leaking hydrogen, or by deposition of dispersed hydrogen reaction catalyst 413 using in-situ pyrolysis of organometallic platinum group metal polymers, or the like.

FIG. 5D depicts cross-sectional view of a second enclosed volume assembly 518. The embodiment depicted in FIG. 5D is similar to that depicted in FIG. 5A. The second enclosed volume assembly 518 depicted in FIG. 5D further includes another sensor 519. In FIG. 5D, the sensor 519 is passed through the flange-type connector region 507 of the first component 501 to reach the enclosed volume 511. The sensor 519 may be, for example, a hygrometer for sensing the presence of water and/or water vapor in the enclosed volume 511 which may indicate the presence of a leakage path between the joining surface 509 and the joining surface 510. As discussed below, the sensor 519 may be useful in methods for detecting the presence of a leakage path between the joining surface 509 and the joining surface 510 by detecting, for example, the presence of water and/or water vapor in, for example, the enclosed volume 511. FIG. 5E depicts a detail view of the enclosed volume 511 and sensor 519. The sensor 519 may further include a coating 520 such as, for example, a sealant or a hydrogen reaction catalyst.

FIG. 5F depicts an end view of the second enclosed volume assembly 518 viewed in the 5F-5F direction depicted in FIG. 5D. In some embodiments, a component includes a plurality of sensors, such as hygrometers (like those discussed further below) and/or temperature sensors (like those discussed above). The plurality of sensors may be arrayed in a circumferential direction on an exterior surface of a connector region. The plurality of sensors may be circumferentially spaced apart from each other, such as uniformly spaced apart from each other. In some embodiments, the plurality of sensors is arrayed to extend around the entire (three hundred sixty degree) circumferential direction to detect hydrogen leaks round the entire circumference of the joint. When a plurality of sensors is used and arrayed in this manner, in some embodiments, at least four sensors are used, with one sensor in each quadrant of the exterior surface of a connector region. For example, the plurality of sensors includes six or more circumferentially spaced sensors. For example, FIG. 5F depicts six circumferentially spaced sensors, including sensor 519, which are passed through the flange-type connector region 507 of the first component 501 to reach the enclosed volume 511 (FIG. 5D).

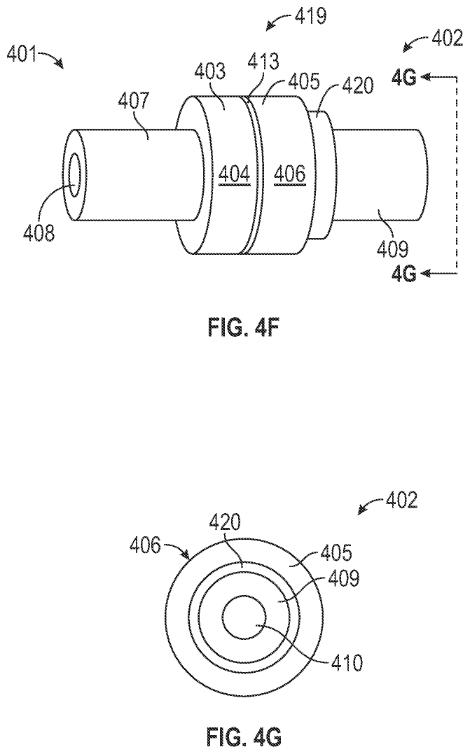

FIG. 6 depicts a cross-sectional view of a fitted flange assembly 600 of a first component 601 including a conduit region 602 and a second component 603 including a conduit region 604. The first component 601 may be connected to the second component 603 to fluidly connect a flow path 605 of the conduit region 602 of the first component 601 with a flow path 606 of the conduit region 604 of the second component 603, forming a continuous flow path for a fuel including diatomic hydrogen to flow through the fitted flange assembly 600. The first component 601 includes a flange-type connector region 607 having a joining surface 608, and, similarly, the second component 603 includes flange-type connector region 609 having a joining surface 610. The flange-type connector region 609 of the second component 603 also includes a protrusion 611 for fitting into a recess 612 formed in the flange-type connector region 607 of the first component 601.

When the first component 601 and the second component 603 are joined together, the joining surface 608 of the first component 601 is positioned to oppose the joining surface 610 of the second component 603, but, even if the joining surface 608 of the first component 601 abuts the joining surface 610 of the second component 603, the diatomic hydrogen may leak between the joining surface 608 and the joining surface 610, forming a hydrogen leakage path.

A hydrogen reaction catalyst 613 is located between the protrusion 611 and the recess 612 at the leakage path between the joining surface 608 of the first component 601 and the joining surface 610 of the second component 603 to react diatomic hydrogen if the diatomic hydrogen leaks from the flow path 605 and the flow path 606. The hydrogen reaction catalyst 613 may be positioned between the protrusion 611 and the recess 612 by various suitable means discussed above such as, for example, as a coating, as an electroplated surface, as a paint, by dispersing the hydrogen reaction catalyst in penetrating oil to distribute the hydrogen reaction catalyst between mating surfaces of joints to mitigate leakage and react with any leaking hydrogen, or by deposition of dispersed hydrogen reaction catalyst using in-situ pyrolysis of organometallic platinum group metal polymers, or the like.

In some embodiments, a temperature sensor 614 is in thermal contact with the hydrogen reaction catalyst 613 for detecting an increase in temperature caused by reaction of the leaking diatomic hydrogen by the hydrogen reaction catalyst 613 in a manner similar to temperature sensor 414 discussed herein.

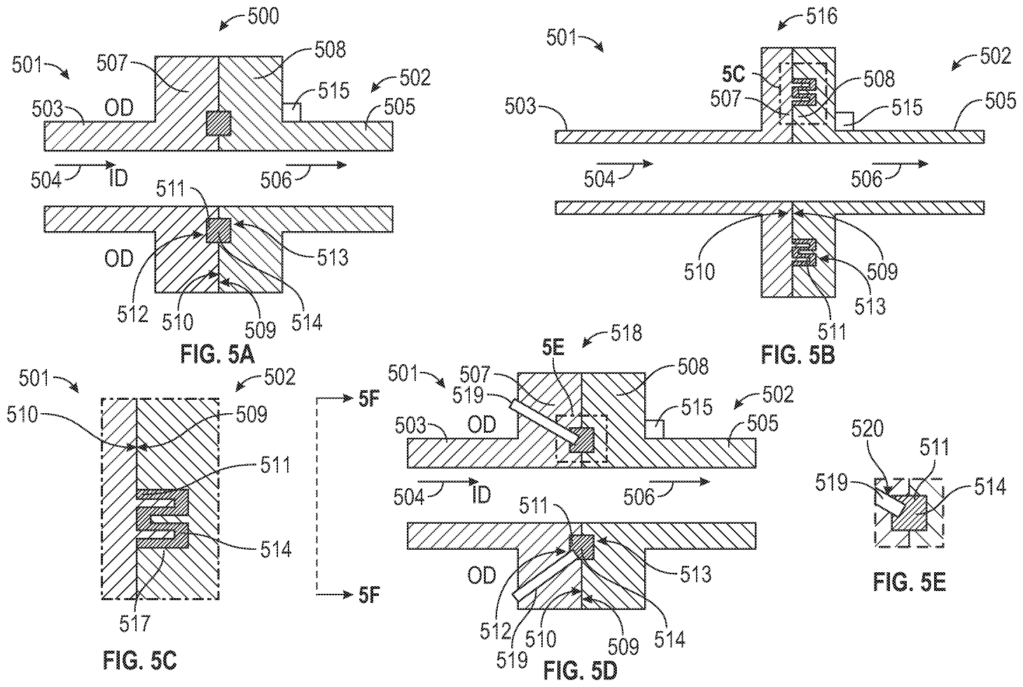

FIG. 7A depicts a cross-sectional view of a first three-component assembly 700 including a first component 701, a second component 702, and a third component 703. In the depicted embodiment and similar to the connector regions discussed above, the connector region of the first component 701 is a flange-type connector region 704, and the connector region of the second component 702 is a flange-type connector region 705. This connection between the first component 701 and the second component 702 fluidly connects a flow path 706 in a conduit region 707 of the first component 701 with a flow path 708 in a conduit region 709 of the second component 702, forming a continuous flow path for the fuel including diatomic hydrogen to flow through the first three-component assembly 700. The flange-type connector region 704 of the first component 701 includes an external surface 710, and the flange-type connector region 705 of the second component 702 also includes an external surface 711. The flange-type connector region 704 of the first component 701 is joined to the flange-type connector region 705 of the second component 702, forming a joint. The flanges can be attached to each other by conventional means including, e.g., bolts, welding, or the like and may further include, for example, a seal or a gasket.

When the first component 701 and the second component 702 are joined together, a joining surface 712 of the first component 701 is positioned to oppose a joining surface 713 of the second component 702. The third component 703 may be a housing or other enclosure positioned around the flange-type connector region 704 and the flange-type connector region 705 to at least partially enclose the flange-type connector region 704 and the flange-type connector region 705 and to form an enclosed volume 714 with the flange-type connector region 704 and the flange-type connector region 705. As depicted, the third component 703 may contact the external surface 710 of the first component 701 and the external surface 711 of the second component 702. The third component 703 may function as clamp (e.g., interference fit) around the joint or be attached to the flange-type connector region 704 and the flange-type connector region 705 by suitable means, such as bolts.

Nonetheless, even when the third component 703 positioned at the joint between the joining surface 712 of the first component 701 that abuts the joining surface 713 of the second component 702, the diatomic hydrogen may leak between the joining surface 712 and the joining surface 713, forming a hydrogen leakage path. With the third component 703 surrounding a terminus of the hydrogen leakage path, the hydrogen may leak into the enclosed volume 714 and a hydrogen reaction catalyst 715 may be positioned within the enclosed volume 714 at the leakage path between the joining surface 712 of the first component 701 and the joining surface 713 of the second component 702 to react diatomic hydrogen if the diatomic hydrogen leaks from the flow path 706 and the flow path 708. The hydrogen reaction catalyst 715 may be positioned within the enclosed volume 714 by various suitable means discussed above such as, for example, as a coating, as an electroplated surface, as a paint, by dispersing the hydrogen reaction catalyst in penetrating oil to distribute the hydrogen reaction catalyst between mating surfaces of joints to mitigate leakage and react with any leaking hydrogen, or by deposition of dispersed hydrogen reaction catalyst using in-situ pyrolysis of organometallic platinum group metal polymers, or the like.

In some embodiments, a temperature sensor 716 is in thermal contact with the hydrogen reaction catalyst 715 for detecting an increase in temperature caused by reaction of the leaking diatomic hydrogen by the hydrogen reaction catalyst 715 in a manner similar to temperature sensor 414 discussed herein.

FIG. 7B depicts a cross-sectional view of a second three-component assembly 717 including a first component 701, a second component 702, and a third component 703. Similarly, as in FIG. 7A, when the first component 701 and the second component 702 are joined together, the joining surface 712 of the first component 701 is positioned to oppose the joining surface 713 of the second component 702. As depicted in FIG. 7B, the third component 703 is a cover plate, facing or otherwise contacting the external surface 710 of the first component 701. By contrast with the first three-component assembly 700, the flange-type connector region 705 of the second component 702 includes an overhang region 718, similar to the overhang region 416 discussed above, and the third component 703 joins with the second component 702 at an external surface 711 on the overhang region 718. But, even with the third component 703 positioned at the joint between the joining surface 712 of the first component 701 that abuts the joining surface 713 of the second component 702, the diatomic hydrogen may leak between the joining surface 712 and the joining surface 713, forming a hydrogen leakage path. For at least this reason, a hydrogen reaction catalyst 715 is positioned at a terminus of the leakage path between the joining surface 712 of the first component 701 and the joining surface 713 of the second component 702 to react diatomic hydrogen if the diatomic hydrogen leaks from the flow path 706 and the flow path 708. Here, the hydrogen reaction catalyst 715 is positioned transverse to the flow path 706 and, in particular, is depicted as perpendicular to the flow path 706. By contrast, the hydrogen reaction catalyst 715 in FIG. 7A is positioned parallel to the flow path. The hydrogen reaction catalyst may be positioned at a terminus of the leakage path between the joining surface 712 of the first component 701 and the joining surface 713 of the second component 702 by various suitable means discussed above such as, for example, as a coating, as a coated gasket, as an electroplated surface, as a paint, by dispersing the hydrogen reaction catalyst in penetrating oil to distribute the hydrogen reaction catalyst between mating surfaces of joints to mitigate leakage and react with any leaking hydrogen, or by deposition of dispersed hydrogen reaction catalyst using in-situ pyrolysis of organometallic platinum group metal polymers, or the like.

FIG. 7C depicts a cross-sectional view of a third three-component assembly 719 including a first component 701, a second component 702, and a third component 703. Similarly, as in FIG. 7A, when the first component 701 and the second component 702 are joined together, the joining surface 712 of the first component 701 is positioned to oppose the joining surface 713 of the second component 702. The third component 703 shown in FIG. 7C is also a faceplate that faces at least one external surface of each of the first component 701 and the second component 702. More specifically, the third component 703 depicted in FIG. 7C has an L-shape and contacts an external surface 710 of the first component 701 and an external surface 711 of the second component 702. The third component 703 includes a portion, such as a first leg 720, that contacts the external surface 710 of the first component 701. Another portion, such as a second leg 721, spans the joining surface 712 of the first component 701 and the joining surface 713 of the second component 702. But, even with the third component 703 positioned at the joint between the joining surface 712 of the first component 701 that abuts the joining surface 713 of the second component 702, the diatomic hydrogen may leak between the joining surface 712 and the joining surface 713, forming a hydrogen leakage path. For at least this reason, a hydrogen reaction catalyst 715 is positioned at the terminus of the leakage path between the joining surface 712 of the first component 701 and the joining surface 713 of the second component 702 to react diatomic hydrogen if the diatomic hydrogen leaks from the flow path 706 and the flow path 708. Here, the hydrogen reaction catalyst 715 also has an L-shape with a portion, such as a first leg portion 722, positioned transverse to the flow path 706 and a portion, such as a second leg portion 723, positioned parallel to the flow path 706. For example, the first leg portion 722 of the hydrogen reaction catalyst 715 may be formed on the first leg 720, and the second leg portion 723 of the hydrogen reaction catalyst 715 may be formed on the second leg 721. The hydrogen reaction catalyst 715 may be positioned at a terminus of the leakage path between the joining surface 712 of the first component 701 and the joining surface 713 of the second component 702 by various suitable means discussed above such as, for example, as a coating, as a coated gasket, as an electroplated surface, as a paint, by dispersing the hydrogen reaction catalyst in penetrating oil to distribute the hydrogen reaction catalyst between mating surfaces of joints to mitigate leakage and react with any leaking hydrogen, or by deposition of dispersed hydrogen reaction catalyst using in-situ pyrolysis of organometallic platinum group metal polymers, or the like.

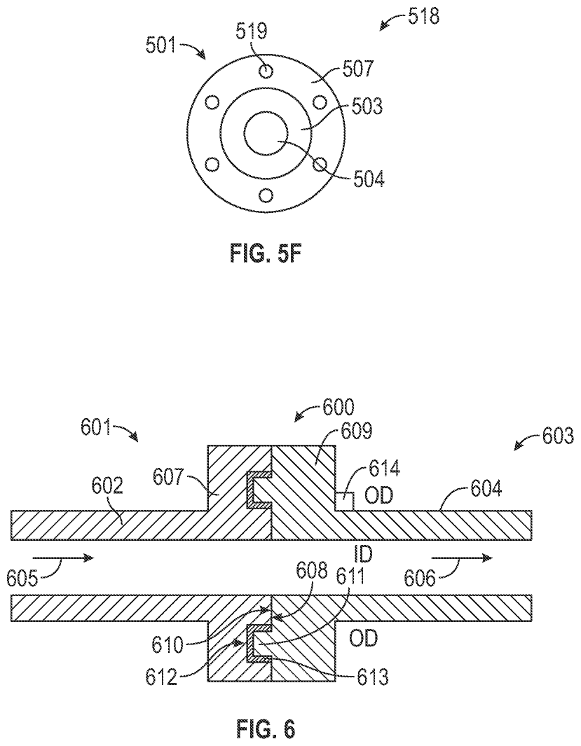

FIG. 8 depicts a cross-sectional view of a bayonet-flange assembly 800 including a first component 801 and a second component 802. The first component 801 may be connected to the second component 802 to fluidly connect a flow path 803 in a conduit region 804 of the first component 801 with a flow path 805 in a conduit region 806 of the second component 802 forming a continuous flow path for the fuel including diatomic hydrogen to flow through the bayonet-flange assembly 800. The first component 801 includes a flange-type connector region 807 having a joining surface 808, and, similarly, the second component 802 includes a flange-type connector region 809 having a joining surface 810.

When the first component 801 and the second component 802 are joined together, the joining surface 808 of the first component 801 is positioned to oppose the joining surface 810 of the second component 802. The flange-type connector region 807 of the first component 801 includes a bayonet connector region 811 for further securing the connection between the first component 801 and the second component 802. The bayonet connector region 811 may extend into the flow path 805 of the second component 802. The bayonet-flange assembly 800 also includes a seal, such as, for example, a piston seal 812, or a W/E-seal located to contact the bayonet connector region 811 and an inner surface 813 of the conduit region 806 of the second component 802. The inner surface 813 may define the flow path 805 of the second component 802. The second component 802, thus, fits over the bayonet connector region 811 of the first component 801. Nonetheless, even with the joining surface 808 of the first component 801 abutting the joining surface 810 of the second component 802, the diatomic hydrogen may leak between the joining surface 808 and the joining surface 810, forming a hydrogen leakage path. For at least this reason, a hydrogen reaction catalyst 814 can be positioned along the leakage path between the joining surface 808 of the first component 801 and the joining surface 810 of the second component 802, such as on or between the bayonet connector region 811 and the inner surface 813, to react diatomic hydrogen if the diatomic hydrogen leaks from the flow path 803 and the flow path 805. More specifically, the hydrogen reaction catalyst 814 may be positioned on the piston seal 812. The hydrogen reaction catalyst 814 may be positioned on the piston seal 812 by various suitable means discussed above such as, for example, a coating, a paint, or etc.

In some embodiments, a temperature sensor 815 is in thermal contact with the hydrogen reaction catalyst 814 for detecting an increase in temperature caused by reaction of the leaking diatomic hydrogen by the hydrogen reaction catalyst 814 in a manner similar to temperature sensor 414 discussed herein.

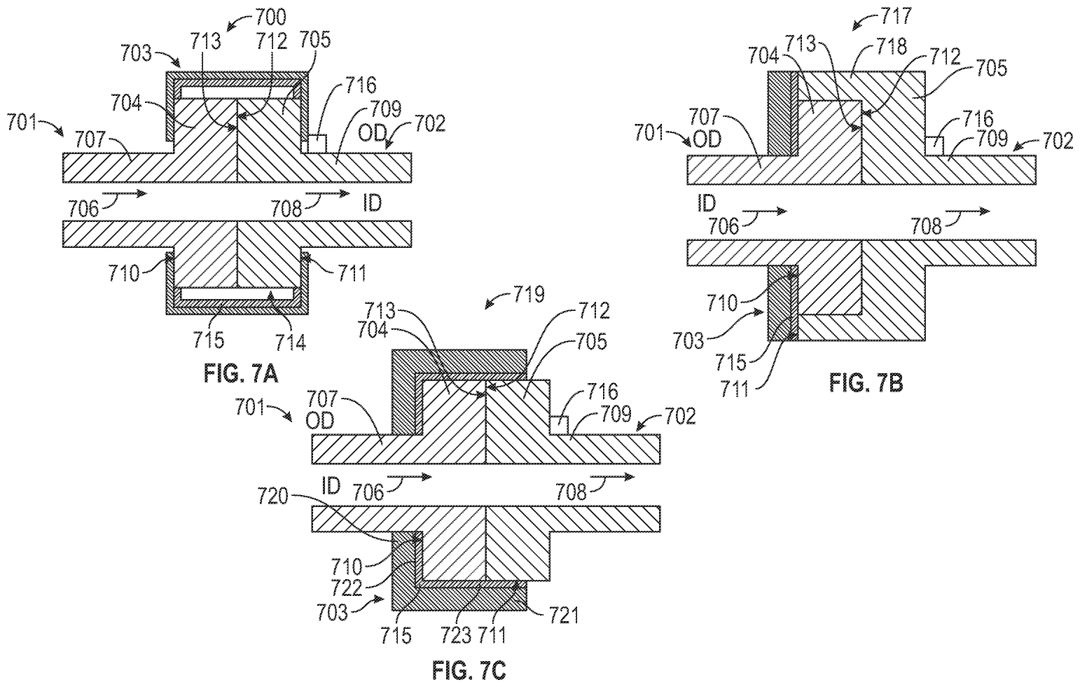

FIG. 9A depicts a cross-sectional view of a first threaded-connection assembly 900 including a first component 901, a second component 902, and a third component 903. The first component 901 includes an end portion 904 that contacts a flow path 905 for conveying a fuel including diatomic hydrogen. The first component 901 may be any threaded component. For example, the first component 901 may be, for example, a bolt. The second component 902 is sandwiched between the first component 901 and the third component 903 with the first component 901 joined to the third component 903 at a threaded connector region 906. The second component 902 may be, for example, a washer or a gasket. The third component 903 is a receiver having internal threads formed on a bore of the third component 903. The first threaded-connection assembly 900 is held together at least by the threaded connector region 906 attaching the first component 901 to the third component 903 and, more specifically, by engaging threads of the first component 901 with threads of the third component 903 at the threaded connector region 906.

The first component 901 further includes a connector region 907 having a joining surface 908. The joining surface 908 faces a joining surface 909 on a connector region 910 of the second component 902. Because it may be possible for the diatomic hydrogen to leak out of the flow path 905 at various locations, a hydrogen reaction catalyst 911 is positioned between joining surface 908 of the first component 901 and joining surface 909 of the second component. to react diatomic hydrogen if the diatomic hydrogen leaks from the flow path 905. The hydrogen reaction catalyst 911 may be positioned at the joining surface 908 of the first component 901 and the joining surface 909 of the second component 902 by various suitable means discussed above such as, for example, on a washer, on a gasket, on a spacer, as a coating, as an electroplated surface, as a paint, by dispersing the hydrogen reaction catalyst in penetrating oil to distribute the hydrogen reaction catalyst between mating surfaces of joints to mitigate leakage and react with any leaking hydrogen, or by deposition of dispersed hydrogen reaction catalyst using in-situ pyrolysis of organometallic platinum group metal polymers, or the like.

In some embodiments, a temperature sensor 912 is in thermal contact with the hydrogen reaction catalyst 911 for detecting an increase in temperature caused by reaction of the leaking diatomic hydrogen by the hydrogen reaction catalyst 911 in a manner similar to temperature sensor 414 discussed herein.

FIG. 9B depicts a cross-sectional view of a second threaded-connection assembly 913 including a first component 901, a second component 902, and a third component 903. The second threaded-connection assembly 913 depicts an alternative location for the hydrogen reaction catalyst 911 but is otherwise the same as the first threaded-connection assembly 900. In the second threaded-connection assembly 913, the hydrogen reaction catalyst 911 is applied to the threaded connector region 906 joining the first component 901 and the third component 903.

FIG. 9C depicts a cross-sectional view of a third threaded-connection assembly 914 including a first component 901, a second component 902, and a third component 903. In the third threaded-connection assembly 914, the first component 901 terminates in the third component 903 such that the end portion 904 does not directly contact the flow path 905. Otherwise, the third threaded-connection assembly 914 is the same as the first threaded-connection assembly 900 (FIG. 9A).

Such differences in the configurations of FIGS. 9A, 9B, and 9C serve only as examples. The hydrogen reaction catalyst 911 may be located at one or both of the regions depicted in FIGS. 9A, 9B, and 9C as well as elsewhere in the assembly. The hydrogen reaction catalyst 911 may be applied to the threaded connector region 906 by various suitable means discussed above such as, for example, a coating, a paint, electroplating, by dispersing the hydrogen reaction catalyst in penetrating oil to distribute the hydrogen reaction catalyst between mating surfaces of joints to mitigate leakage and react with any leaking hydrogen, or by deposition of dispersed hydrogen reaction catalyst using in-situ pyrolysis of organometallic platinum group metal polymers, or etc. In this way, the hydrogen reaction catalyst 911 can be positioned to react diatomic hydrogen if it leaks from the flow path 905. Similarly, the end portion 904 may independently terminate in the third component 903 or contact the flow path 905.

FIG. 10 depicts a cross-sectional view of a bolted-flange assembly 1000 including a first component 1001, a second component 1002, and a third component 1003. The first component 1001 includes a conduit region 1004 having a flow path 1005 and the second component 1002 includes a conduit region 1006 having a flow path 1007. The first component 1001 may be connected to the second component 1002 to fluidly connect the flow path 1005 of the first component 1001 with the flow path 1007 of the second component 1002 forming a continuous flow path for the fuel including diatomic hydrogen to follow through the bolted-flange assembly 1000. The first component 1001 includes a flange-type connector region 1008 having a joining surface 1009, and, similarly, the second component 1002 includes a flange-type connector region 1010 having a joining surface 1011.

When the first component 1001 and the second component 1002 are joined together, the joining surface 1009 of the first component 1001 is positioned to oppose the joining surface 1011 of the second component 1002. A third component 1003, such as a bolt, is provided to secure this connection between the first component 1001 and the second component 1002. Nonetheless, even with the joining surface 1009 of the first component 1001 abutting the joining surface 1011 of the second component 1002, the diatomic hydrogen may leak between the joining surface 1009 and the joining surface 1011, forming a hydrogen leakage path. In the flange-type assemblies depicted in FIGS. 4A to 4E, a hydrogen reaction catalyst is positioned at the joining surface 1009 and the joining surface 1011. In this embodiment, a hydrogen reaction catalyst 1012 is positioned between, e.g., an exterior surface 1013 of the flange-type connector region 1008 of the first component 1001 and a joining surface 1014 of the third component 1003. For example, the hydrogen reaction catalyst 1012 may be positioned on the joining surface 1014 of the third component 1003, such as on the inner portion of a bolt head or a nut. As noted above, the hydrogen reaction catalyst 1012 and the third component 1003 (e.g., a bolt) may be used with other assemblies discussed herein, such as those depicted in FIGS. 4A to 4E. Thus, the hydrogen reaction catalyst 1012 can react diatomic hydrogen if the diatomic hydrogen leaks from the flow path 1005 and the flow path 1007. The hydrogen reaction catalyst 1012 may be positioned between the exterior surface 1013 of the first component 1001 and a joining surface 1014 of the third component 1003 by various suitable means discussed above such as, for example, on a washer, on a gasket, on a spacer, as a coating, as an electroplated surface, as a paint, by dispersing the hydrogen reaction catalyst in penetrating oil to distribute the hydrogen reaction catalyst between mating surfaces of joints to mitigate leakage and react with any leaking hydrogen, or by deposition of dispersed hydrogen reaction catalyst using in-situ pyrolysis of organometallic platinum group metal polymers, or the like.

In some embodiments, a temperature sensor 1015 is in thermal contact with the hydrogen reaction catalyst 1012 for detecting an increase in temperature caused by reaction of the leaking diatomic hydrogen by the hydrogen reaction catalyst 1012 in a manner similar to temperature sensor 414 (FIGS. 4A-4E) discussed herein.

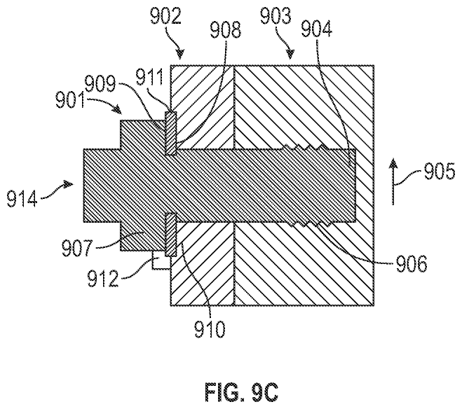

FIG. 11A depicts a cross-sectional view of a first pipe assembly 1100 including a first component 1101 and a second component 1102. The first component 1101 includes a conduit region 1103 including a flow path 1104. The second component 1102 also has a conduit region 1105 including a flow path 1106. The first component 1101 may be connected to the second component 1102 to fluidly connect the flow path 1104 of the first component 1101 with the flow path 1106 of the second component 1102 forming a continuous flow path for the fuel including diatomic hydrogen to follow through the first pipe assembly 1100. While many connector regions may be used such as, for example, a threaded connection between the first component 1101 and the second component 1102, here, a flush connector region 1107 and a flush connector region 1108 are used. The flush connector region 1107 of the first component 1101 may be joined to the flush connector region 1108 of the second component 1102 by, for example, welding, soldering, or brazing. The flush connector region 1107 of the first component 1101 includes a joining surface 1109, and, similarly, the flush connector region 1108 of the second component 1102 includes a joining surface 1110.

When the first component 1101 and the second component 1102 are joined together, the joining surface 1109 of the first component 1101 is positioned to oppose and, more specifically, abut the joining surface 1110 of the second component 1102, but, even if the joining surface 1109 of the first component 1101 abuts the joining surface 1110 of the second component 1102, the diatomic hydrogen may leak between the opposed joining surface 1109 and 1110, such as a result of a weld or braze failure or defect, forming a hydrogen leakage path. For at least this reason, a hydrogen reaction catalyst 1111 is located on an external surface 1112 of the first component 1101 and an external surface 1113 of the second component 1102 at the leakage path between the joining surface 1109 of the first component 1101 and the joining surface 1110 of the second component 1102 to react diatomic hydrogen if the diatomic hydrogen leaks from the flow path 1104 and the flow path 1106. For example, the hydrogen reaction catalyst 1111 may circumscribe a weld between joining surface 1109 and joining surface 1110. The hydrogen reaction catalyst 1111 may be located on the external surface 1112 of the first component 1101 and the external surface 1113 of the second component 1102 by various suitable means discussed above such as, for example, as a coating, as an electroplated surface, as a paint, a tape, by dispersing the hydrogen reaction catalyst in penetrating oil to distribute the hydrogen reaction catalyst between mating surfaces of joints to mitigate leakage and react with any leaking hydrogen, or by deposition of dispersed hydrogen reaction catalyst using in-situ pyrolysis of organometallic platinum group metal polymers, or the like.

In some embodiments, a temperature sensor 1114 is in thermal contact with the hydrogen reaction catalyst 1111 for detecting an increase in temperature caused by reaction of the leaking diatomic hydrogen by the hydrogen reaction catalyst 1111 in a manner similar to temperature sensor 414 discussed herein.

FIG. 11B depicts a cross-sectional view of a three-component pipe assembly 1115 including a first component 1101, a second component 1102, and a third component 1116. In the three-component pipe assembly, the third component 1116, such as a sleave, is positioned at the connection between the first component 1101 and the second component 1102. The third component 1116 is joined to the first component 1101 and the second component 1102 at an external surface 1117 of the first component 1101 and an external surface 1118 of the second component 1102. The hydrogen reaction catalyst 1111 is sandwiched between a portion of the external surface 1112 of the first component 1101, a portion of the external surface 1113 of the second component 1102, and the third component 1116 transverse to the joining surface 1109 and the joining surface 1110 through which diatomic hydrogen may leak.

The hydrogen reaction catalyst 1111 may be sandwiched between a portion of the external surface 1112 of the first component 1101, a portion of the external surface 1113 of the second component 1102, and third component 1116 by various suitable means discussed above such as, for example, a coating, a paint, electroplating, by dispersing the hydrogen reaction catalyst in penetrating oil to distribute the hydrogen reaction catalyst between mating surfaces of joints to mitigate leakage and react with any leaking hydrogen, or by deposition of dispersed hydrogen reaction catalyst using in-situ pyrolysis of organometallic platinum group metal polymers, or etc.

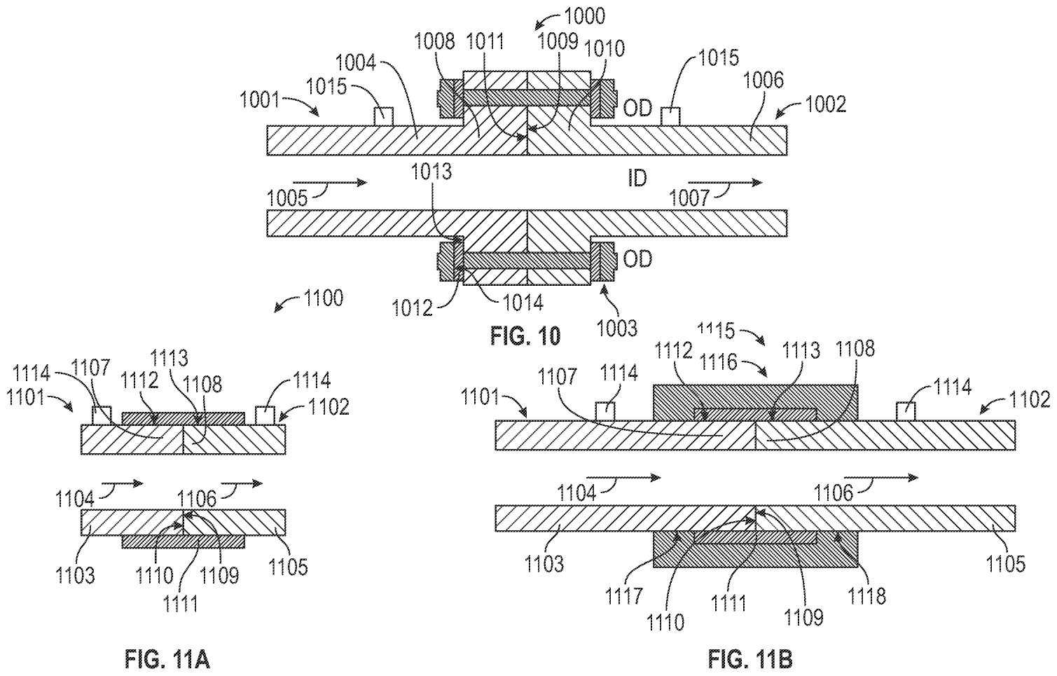

FIG. 12 depicts a cross-sectional view of a double-walled component 1200 having a conduit region 1201 including a flow path 1202 for conveying a fuel including diatomic hydrogen. The double-walled component 1200 may be any double-walled component 1200 having a conduit region 1201. For example, as discuss above. In the depicted embodiment, the double-walled component 1200 includes a flush connector region 1203 having a joining surface 1204 that may be joined with another component (not depicted). In other embodiments, for example, the connector region of the double walled pipe may be, for example, a threaded end of the pipe or a flange end of the pipe. The double-walled component 1200 includes an inner wall 1205 having an inner surface 1206 and an outer surface 1207. The inner surface 1206 defines the flow path 1202. The double-walled component 1200 also includes an outer wall 1208 having an inner surface 1209 and an outer surface 1210. The outer surface 1210 of the outer wall 1208 may be an exterior surface of the double-walled component 1200. The inner wall 1205 and the outer wall 1208 are positioned to define a cavity 1211, therebetween. When the double-walled component 1200 is a vacuum jacketed pipe, for example, a vacuum may be drawn in the cavity 1211 to insulate the hydrogen flowing through the flow path 1202. In the depicted embodiment, a hydrogen reaction catalyst 1212 is positioned within the cavity 1211 and, more specifically, on outer surface 1207 of the inner wall 1205, on the inner surface 1209 of the outer wall 1208, or both, so as to contact and to react diatomic hydrogen if the diatomic hydrogen escapes the flow path 1202, e.g., through a crack or a pin hole in the inner wall 1205 and flows into the cavity 1211

In some embodiments, a temperature sensor 1213 is in thermal contact with the hydrogen reaction catalyst 1212 for detecting an increase in temperature caused by reaction of the leaking diatomic hydrogen by the hydrogen reaction catalyst 1212 in a manner similar to temperature sensor 414 discussed herein.

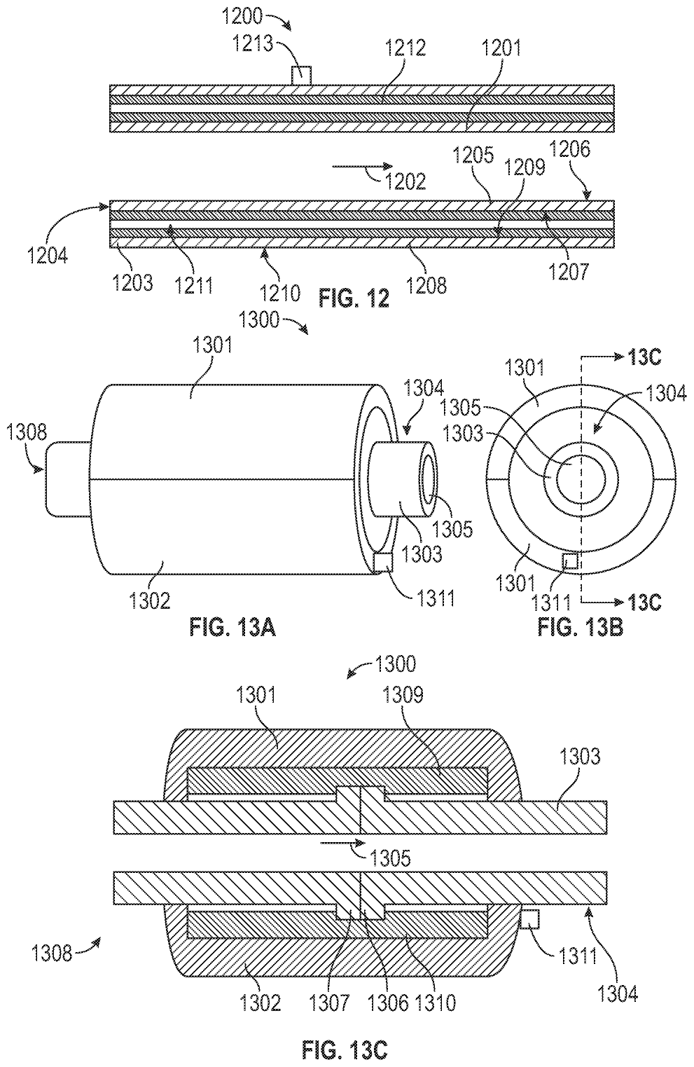

Also disclosed are devices for at least partially enclosing a component that has a conduit region having a flow path to convey a fuel including diatomic hydrogen. The devices can have, e.g., a clamshell design, as depicted in FIGS. 13A to 13C, that is configured to fit over a component, such as a pipe or a tubing, and to detect diatomic hydrogen if it leaks from the flow path of the component.

FIG. 13A depicts a schematic view of a device 1300 having a first housing 1301 and a second housing 1302 to at least partially enclose a portion of a conduit region 1303 of a component 1304. The first housing 1301 and a second housing 1302 collectively form at least a partial enclosure for the component 1304. The component 1304 may be any component of the fuel system 200 of FIG. 3 and/or a gas turbine engine 100 (FIGS. 1-3) discussed above. For example, the component 1304 may be located along a flow path connecting the fuel tank 210 to a pump 230 (FIG. 3), a heat exchanger 162 (FIG. 2), a metering valve 240 (FIG. 3), a bypass valve, a shutoff valve 204 (FIG. 3), an accumulator, a venting structure, a fuel nozzle 174 (FIG. 3), a fuel manifold 172 (FIG. 3), a vaporizer 221/223 (FIG. 3), or a fuel injector. Further, for example, the component 1304 may form a portion of a pump 230, a heat exchanger 162, a metering valve 240, a bypass valve, a shutoff valve 204, an accumulator, a venting structure, a fuel nozzle 174, a fuel manifold 172, a vaporizer 221/223, or a fuel injector in an aircraft. The conduit region 1303 of the component 1304 includes a flow path 1305 for conveying a fuel including diatomic hydrogen.

FIG. 13B is an end view of the device depicted in FIG. 13A and FIG. 13C depicts a cross-sectional view of the embodiment depicted in FIG. 13B, taken along line 13C-13C in FIG. 13B. The device 1300 may be positioned to at least partially enclose a joint such as, for example, a joint between a first flange connector region 1306 of the component 1304 and a second flange connector region 1307 of a second component 1308. In this embodiment, a hydrogen reaction catalyst 1309 is positioned within a volume enclosed by the first housing 1301 and a hydrogen reaction catalyst 1310 is positioned within a volume enclosed by the second housing 1302, respectively, so as to contact and to react diatomic hydrogen if the diatomic hydrogen escapes the flow path 1305, e.g., by leaking through the joint between the first flange connector region 1306 and the second flange connector region 1307. The hydrogen reaction catalyst 1309 and the hydrogen reaction catalyst 1310 may be so positioned by various suitable means discussed above such as, for example, a coating, a paint, electroplating, by dispersing the hydrogen reaction catalyst in penetrating oil to distribute the hydrogen reaction catalyst between mating surfaces of joints to mitigate leakage and react with any leaking hydrogen, or by deposition of dispersed hydrogen reaction catalyst using in-situ pyrolysis of organometallic platinum group metal polymers, or etc.

In some embodiments, a temperature sensor 1311 is in thermal contact with the hydrogen reaction catalyst 1309 or the hydrogen reaction catalyst 1310 for detecting an increase in temperature caused by reaction of the leaking diatomic hydrogen by the hydrogen reaction catalyst 1309 or the hydrogen reaction catalyst 1310 in a manner similar to temperature sensor 414 (FIGS. 4A-4E) discussed herein.

When diatomic hydrogen leaks from a flow path and reacts in the presence of a hydrogen reaction catalyst, reaction products, such as heat and/or water, may be formed. Reaction products may be detected by one or more sensors such as a temperature sensor and/or a hygrometer. In this way, one or more sensors may be used in a method for detecting leaking diatomic hydrogen. For example, the hydrogen combustion reaction is exothermic and forms water, when diatomic hydrogen leaks from a conduit conveying the fuel that includes the diatomic hydrogen and is combusted by the hydrogen reaction catalyst, a local temperature increase may be generated and a local increase in water and/or water vapor concentration may be generated. In some embodiments, the sensor, such as the temperature sensor and/or the hygrometer, is in communication with a controller or another system for transmitting data from the sensor to the controller or the other system. For example, the sensor may be in communication with the controller or the other system by one or more electrical leads. The controller or other system may, in some embodiments, generate an alert or notification based on the data from the sensor. In some embodiments, the control is configured to perform a method for detecting and/or mitigating a leakage of a fluid containing diatomic hydrogen such as the methods disclosed herein.

A local temperature increase can be detected by a temperature sensor, such as the temperature sensor 414 (FIGS. 4A-4E) or the ring-shaped temperature sensor 420 (FIGS. 4F and 4G), in thermal contact with the hydrogen reaction catalyst. As noted above, the temperature sensor 414 may be used with any one of the embodiments shown and described with reference to FIGS. 4A to 13C, and, in some embodiments, a disclosed component, an assembly, and/or a device includes a temperature sensor in thermal contact with the hydrogen reaction catalyst. For example, the temperature sensor may be positioned next to a joint, on a conduit, on an external surface of the component, separated from the hydrogen reaction catalyst by one or more thermal conductors, or the like as long as the temperature sensor is in thermal contact with the hydrogen reaction catalyst. Further, for example, the temperature sensor, such as a ring-shaped temperature sensor, may be attached to an external surface of a connector region. For example, the ring-shaped temperature sensor may be in continuous contact with a connector region along the entire outer edge of a side face of the ring-shaped temperature sensor. The ring-shaped temperature sensor may be circumferentially in contact with the connector region, such as for one rotation (i.e., for three-hundred sixty degrees). The temperature sensor can be used in a method of detecting diatomic hydrogen leaking from a conduit in an aircraft, a fuel system, and/or a gas turbine engine.

Similarly, a local increase in water and/or water vapor concentration caused by reaction of leaking diatomic hydrogen in the presence of a hydrogen reaction catalyst can be detected by a hygrometer in diffusive contact with the hydrogen reaction catalyst. A hygrometer is in diffusive contact with a hydrogen reaction catalyst when water and/or water vapor can diffuse from the hydrogen reaction catalyst to the hygrometer. For example, the water and/or water vapor could diffuse through a fluid, such as air, a permeable solid, such as a membrane, and/or a vacuum. Similar to the above, a hygrometer, such as some embodiments of sensor 519 (FIGS. 5D and 5E), may be used with any one of the embodiments shown and described with reference to FIGS. 4A to 13C, and, in some embodiments, a disclosed component, an assembly, and/or a device includes a hygrometer in diffusive contact with the hydrogen reaction catalyst. For example, the hygrometer may be positioned next to a joint, on a conduit, on an external surface of the component, separated from the hydrogen reaction catalyst by one or more permeable layers, or the like as long as the hygrometer is in diffusive contact with the hydrogen reaction catalyst. The hygrometer can be used in a method of detecting diatomic hydrogen leaking from a conduit in an aircraft, a fuel system, and/or a gas turbine engine.

Disclosed are methods of mitigating a diatomic fuel including diatomic hydrogen leak. Such methods include reacting the diatomic hydrogen with a hydrogen reaction catalyst including a platinum group metal, when the diatomic hydrogen is leaking from a conduit having a flow path for conveying a fuel including the diatomic hydrogen and the hydrogen reaction catalyst is positioned outside of the flow path. Here, the leak is mitigated at least because some of the leaking diatomic hydrogen is reacted.

Further disclosed are methods of detecting a diatomic fuel including diatomic hydrogen leak. Such methods include reacting the diatomic hydrogen with a hydrogen reaction catalyst including a platinum group metal to generate a reaction product such as heat, water, and/or water vapor, and detecting the reaction product with a sensor, when the diatomic hydrogen is leaking from conduit having a flow path for conveying a fuel including the diatomic hydrogen. The hydrogen reaction catalyst is positioned outside of the flow path, and the sensor is in thermal contact and/or diffusive with the hydrogen reaction catalyst. In some embodiments, the reaction product is heat, the sensor is a temperature sensor, and the temperature sensor is in thermal contact with the hydrogen reaction catalyst. In some embodiments, the reaction product is water and/or water vapor, the sensor is a hygrometer, and the hygrometer is in diffusive contact with the hydrogen reaction catalyst.

In some embodiments, the disclosed methods are performed using one or more of the disclosed components, assemblies, and/or devices. In some embodiments, the disclosed methods of detecting a diatomic hydrogen leak in an aircraft such as, for example, in a fuel system and/or a gas turbine engine.

Also disclosed is a method for maintaining a component, assembly, and/or device by reapplying, refreshing, and/or replenishing the hydrogen reaction catalyst at different time points after first operation of a component, assembly, and/or device. In some embodiments, the hydrogen reaction catalyst may be reapplied, refreshed, and/or replenished at different time points after first operation of a component, assembly, and/or device. For example, the hydrogen reaction catalyst may be reapplied, refreshed, and/or replenished after about 1 month of use, 2 months of use, 3 months of use, 1 year of use, 2 years of use, or 3 years of use. Further, for example, the hydrogen reaction catalyst may be reapplied, refreshed, and/or replenished at regular maintenance and/or inspection intervals.

In embodiments of the forgoing description, a hydrogen reaction catalyst is described for use with a fluid including diatomic hydrogen; however, such embodiments are non-limiting. As noted above, the hydrogen reaction catalyst may be a catalyst that includes a platinum group metal. Such catalysts may be used to catalyze other reactions beyond those including diatomic hydrogen, and any fluid including a reactive compound, as defined above, can be used in place of the fluid including diatomic hydrogen in each of the embodiments discussed above. In the embodiments above where the fluid includes a reactive compound, any catalyst including a platinum group metal can be used in place of the hydrogen reaction catalyst. For example, in some embodiments, the reactive compound is a hydrocarbon, such as methane, and in such cases the catalyst may be a combustion catalyst.

Further aspects of the present disclosure are provided by the subject matter of the following clauses.

A component includes a conduit region having a flow path to convey a fluid having a reactive compound. The component includes a connector region having a joining surface to fluidly connect the conduit region to another component, and a catalyst having a platinum group metal. The flow path is free of the catalyst and the catalyst is positioned to contact and react the reactive compound if the reactive compound escapes the flow path.

The component of the preceding clause, such that the connector region has an external surface, and the catalyst is located on the joining surface of the connector and/or the external surface of the connector.

The component of any of the preceding clauses, such that the connector region includes at least one connector chosen from a flange connector, a barb connector, a bayonet connector, a threaded connector, a swage-lock connector, a v-band connector, a welded connection, a soldered connection, and combinations thereof.

The component of any of the preceding clauses, such that the platinum group metal is platinum, palladium, or a combination thereof.

The component of any of the preceding clauses, such that the component further includes a temperature sensor in thermal contact with the hydrogen reaction catalyst.

The component of any of the preceding clauses, such that the component further includes a temperature sensor in thermal contact with the hydrogen reaction catalyst, and one or more electrical leads for transmitting the temperature data to a controller or other system.

The component of any of the preceding clauses, such that the catalyst is present in at least one entity chosen from a paint, a coating, a tape, an electroplated surface, a gasket, and combinations thereof.

The component of any of the preceding clauses, such that the catalyst further includes a supporting material for the platinum group metal and the supporting material is chosen from a carbon support, a metal mesh, a metal-oxide support, a ceramic support, an electroplated surface, and combinations thereof.

The component of any of the preceding clauses, such that the catalyst includes nanoparticles having the platinum group metal.

The component of any of the preceding clauses, such that the fluid including the reactive compound is a fuel including the reactive compound.

An assembly including a first component according to according to any of the preceding clauses, and a second component having a second component conduit region having a second component flow path to convey the fluid including the reactive compound and a second component connector region having a joining surface to fluidly connect the second component conduit region to the first component conduit region. The second component flow path is in fluid communication with the first component flow path, and the second component flow path is free of the hydrogen reaction catalyst.

The assembly of the preceding clause, such that the catalyst is in contact with the second component joining surface and the catalyst is in contact with the first component joining surface.

The assembly of any of the preceding clauses, such that the first component connector region is a flange, the second component connector region is a flange, and the catalyst is sandwiched between the first component connect region and the second component connect region.

The assembly of any of the preceding clauses, such that the first component joining surface is in contact with the second component joining surface, the catalyst is in contact with the first component, the catalyst is in contact with the second component, and the catalyst is positioned transverse to the joining surface of the first component and the joining surface of the second component.

The assembly of any of the preceding clauses, such that the first component connector region is a flange, the second component connector region is a flange, and the catalyst is positioned on an external surface of the first component flange and the second component flange.

The assembly of any of the preceding clauses, such that the first component connector region has a protrusion and the second component connector region has a recess, wherein the protrusion fits into the recess, and the catalyst is sandwiched between the protrusion and the recess.

The assembly of any of the preceding clauses, such that the assembly further includes an at least partially enclosed volume having at least one wall at least partially defined by at least one of the first component or the second component, and the catalyst is in contact with an enclosed portion of the at least partially enclosed volume.

The assembly of any of the preceding clauses, such that the at least partially enclosed volume has a tortuous path with the catalyst positioned on a wall of the tortuous path.

The assembly of any of the preceding clauses, such that the assembly further includes a third component in contact with the catalyst and the third component is in contact with both the first component and the second component to position the catalyst transverse to a joint between the first component and the second component.

An assembly including a first component according to any of the preceding clauses, and a second component at least partially surrounding the conduit region of the first component. The catalyst is sandwiched between first component and the second component.

The assembly of the preceding clause, such that the first component includes a threaded region.

The assembly of any of the preceding clauses, such that the conduit region has a double walled region surrounding the flow path and the catalyst is positioned within the double walled region.

The assembly of any of the preceding clauses, such that the assembly further includes a temperature sensor in thermal contact with the hydrogen reaction catalyst, and one or more electrical leads for transmitting the temperature data to a controller or other system.

The assembly of any of the preceding clauses, such that the fluid including the reactive compound is a fuel including the reactive compound.

An aircraft component including the component of any of the preceding clauses and/or the assembly according to any of the preceding clauses.

A gas turbine engine including the component of any of the preceding clauses, a reaction housing for reacting the fuel includes the reactive compound, and a fuel injector to provide the fuel includes the reactive compound to the reaction housing. The component is in fluid communication with the fuel injector.

A gas turbine engine including the assembly according to any of the preceding clauses, a reaction housing for reacting the fuel including the reactive compound, and a fuel injector to provide the fuel including the reactive compound to the reaction housing. The assembly is in fluid communication with the fuel injector.

The gas turbine engine according to any of the preceding clauses, such that the fuel including the reactive compound has at least 90 weight % the reactive compound by total weight of the fuel.

The gas turbine engine according to any of the preceding clauses, such that the fuel including the reactive compound has at least 95 weight % the reactive compound by total weight of the fuel.

The gas turbine engine according to any of the preceding clauses, such that the fuel including the reactive compound has at least 99 weight % the reactive compound by total weight of the fuel.

A fuel system including the component of any of the preceding clauses, a fuel tank for storing the fuel including the reactive compound, and a pump in fluid communication with the component and the fuel tank.

A fuel system including the assembly according to any of the preceding clauses, a fuel tank for storing the fuel having the reactive compound, and a pump in fluid communication with the assembly and the fuel tank.

The fuel system according to any of the preceding clauses, such that the fuel having the reactive compound has at least 90 weight % the reactive compound by total weight of the fuel.

The fuel system according to any of the preceding clauses, such that the fuel having the reactive compound has at least 95 weight % the reactive compound by total weight of the fuel.

The fuel system according to any of the preceding clauses, such that the fuel having the reactive compound has at least 99 weight % the reactive compound by total weight of the fuel.

The fuel system according to any of the preceding clauses, such that the fuel having the reactive compound is a liquid.

The fuel system according to any of the preceding clauses, such that the fuel system further includes a vaporizer downstream from the fuel tank and the vaporizer converts the fuel including the reactive compound from a liquid phase to a supercritical or a gas phase.

An aircraft including the gas turbine engine according to any of the preceding clauses.

An aircraft including the fuel system according to any of the preceding clauses.

An aircraft including the gas turbine engine according to any of the preceding clauses and the fuel system according to any of the preceding clauses, such that the fuel system provides the fuel including the reactive compound to the gas turbine engine for reaction in the reaction housing.

A device for at least partially enclosing a component that has a conduit region having a flow path to convey a fluid having the reactive compound. The device includes a first housing to at least partially enclosed a first portion of the conduit region of the component, a second housing to at least partially enclosed a second portion of the conduit region of the component, and a catalyst including a platinum group metal. The catalyst is positioned within the first housing and/or the second housing and the catalyst is positioned to contact and react the reactive compound if the reactive compound escapes the flow path.

The device according to the preceding clause, such that the platinum group metal is platinum, palladium, or a combination thereof.

The device according to any of the preceding clauses, such that the device further includes a temperature sensor in thermal contact with the hydrogen reaction catalyst.

The device according to any of the preceding clauses, such that the catalyst is present in at least one entity chosen from a paint, a coating, a tape, an electroplated surface, a gasket, and combinations thereof.

The device according to any of the preceding clauses, such that the catalyst further includes a supporting material for the platinum group metal and the supporting material is chosen from a carbon support, a metal mesh, a ceramic support, an electroplated surface, and combinations thereof.

The device according to any of the preceding clauses, such that the catalyst including nanoparticles having the platinum group metal.

The device according to any of the preceding clauses, such that the device has a clamshell configuration.

The device of any of the preceding clauses, such that the device further includes a temperature sensor in thermal contact with the hydrogen reaction catalyst, and one or more electrical leads for transmitting the temperature data to a controller or other system.

The device of any of the preceding clauses, such that the fluid including a reactive compound is a fuel including the reactive compound.

A method of mitigating a leak of fluid having a reactive compound. The method includes reacting the reactive compound with a catalyst having a platinum group metal. The reactive compound is leaking from a conduit having a flow path for conveying a fluid including the reactive compound and the catalyst is positioned outside of the flow path.

A method of detecting a leak of a fluid including a reactive compound. The method includes reacting the reactive compound with a catalyst having a platinum group metal to generate a temperature increase, and detecting the temperature increase with a temperature sensor. The reactive compound is leaking from a conduit having a flow path for conveying a fluid including the reactive compound, the catalyst is positioned outside of the flow path, and the temperature sensor is in thermal contact with the hydrogen reaction catalyst.

The method according to any of the preceding clauses, such that the platinum group metal is platinum, palladium, or a combination thereof.

The method according to any of the preceding clauses, such that the device further includes a temperature sensor in thermal contact with the hydrogen reaction catalyst.

The method according to any of the preceding clauses, such that the catalyst is present in at least one entity chosen from a paint, a coating, a tape, an electroplated surface, a gasket, and combinations thereof.

The method according to any of the preceding clauses, such that the catalyst further includes a supporting material for the platinum group metal and the supporting material is chosen from a carbon support, a metal mesh, a ceramic support, an electroplated surface, and combinations thereof.

The method according to any of the preceding clauses, such that the catalyst including nanoparticles having the platinum group metal.

The method of any of the preceding clauses, such that the fluid including the reactive compound is a fuel including the reactive compound.

The method of any of the preceding clauses, such that the sensor is in communication with a controller.

The method of any of the preceding clauses, such that sensor includes one or more electrical leads in communication with a controller.

The method of any of the preceding clauses, such that the sensor is in communication with a controller and the controller is configured to generate an alert or notification based on data transmitted from the sensor to the controller.

An embodiment according to any of the proceeding clauses, such that the catalyst selectively converts the reactive compound to water.

An embodiment according to any of the proceeding clauses, such that the catalyst has a mole % selectivity for converting the reactive compound to water of at least 60 mole % based on the total moles of the reactive compound contacting the hydrogen reaction catalyst.

An embodiment according to any of the proceeding clauses, such that the catalyst has a mole % selectivity for converting the reactive compound to water of at least 80 mole % based on the total moles of the reactive compound contacting the hydrogen reaction catalyst.

An embodiment according to any of the proceeding clauses, such that the catalyst has a mole % selectivity for converting the reactive compound to water of at least 90 mole % based on the total moles of the reactive compound contacting the hydrogen reaction catalyst.

An embodiment according to any of the proceeding clauses, such that the catalyst is a hydrogen combustion catalyst.

An embodiment according to any of the proceeding clauses, such that the selective combustion reaction is catalytic hydrogen combustion.

A component including a double-walled conduit having a flow path for conveying a fuel including a reactive compound and a catalyst positioned within the double-walled conduit. The flow path is free from the hydrogen reaction catalyst.

The component according to the previous clause, such that the double-walled conduit includes an inner wall having and inner surface and an outer surface, the inner surface defining the flow path.

The component according to any of the previous clauses, such that the catalyst is applied to the outer surface of the inner wall.

The component according to any of the previous clauses, such that the double-walled conduit includes an outer wall having an inner surface, the catalyst being applied to the inner surface of the outer wall.

An embodiment according to any of the preceding clauses, such that at least one component includes a sensor positioned between a joining surface on a first component and a joining surface on a second component.

An embodiment according to any of the preceding clauses, such that at least one component includes a sensor positioned between a joining surface on a first component and a joining surface on a second component. The sensor includes a coating and the coating is a sealant or a hydrogen reaction catalyst.

An embodiment according to any of the preceding clauses, such that at least one component includes a hygrometer for detecting the presence of water and/or water vapor where the hygrometer is positioned between a joining surface on a first component and a joining surface on a second component.

An embodiment according to any of the preceding clauses, such that at least one component includes a hygrometer for detecting the presence of water and/or water vapor where the hygrometer is positioned in an enclosed volume between a joining surface on a first component and a joining surface on a second component.

An embodiment according to any of the preceding clauses, such that at least one component includes a hygrometer for detecting the presence of water and/or water vapor where the hygrometer is positioned though a connector region on a first component to be positioned in an enclosed volume between a joining surface on a first component and a joining surface on a second component.

An embodiment according to any of the preceding clauses, such that at least one component includes a plurality of sensors for detecting a reaction product formed from reacting the reactive compound in the presence of a hydrogen reaction catalyst, and each sensor is in thermal and/or diffusive contact with the hydrogen reaction catalyst.

An embodiment of the preceding clause, such that the plurality of sensors is arrayed in a circumferential direction an exterior surface of a connector region.

An embodiment of any of the preceding clauses, such that the plurality of sensors is circumferentially spaced apart from each other, such as uniformly spaced apart from each other.

An embodiment of any of the preceding clauses, such that the plurality of sensors is arrayed to extend around the entire (three hundred sixty degree) circumferential direction to detect hydrogen leaks round the entire circumference of the joint.

An embodiment of the preceding clause, such that at least four sensors are used, with one sensor in each quadrant of the exterior surface of a connector region; for example, the plurality of sensors may include six or more circumferentially spaced sensors.

An embodiment according to any of the preceding clauses, such that at least one component includes from one to ten sensors for detecting a reaction product formed from reacting the reactive compound in the presence of a hydrogen reaction catalyst, and each sensor is in thermal and/or diffusive contact with the hydrogen reaction catalyst.

An embodiment according to the preceding clause, such that at least one of the sensors is a temperature sensor, the reaction product detected is heat, and the temperature sensor is in thermal contact with the hydrogen reaction catalyst.

An embodiment according to any of the preceding clauses, such that at least one of the sensors is a hygrometer, the reaction product detected is water and/or water vapor, and the hygrometer is in diffusive contact with the hydrogen reaction catalyst.

An embodiment according to any of the preceding clauses, such that at least one component includes from one to six sensors.

An embodiment according to any of the preceding clauses, such that at least one component includes one sensor.

An embodiment according to any of the preceding clauses, such that at least one component includes two sensors.

An embodiment according to any of the preceding clauses, such that at least one component includes three sensors.

An embodiment according to any of the preceding clauses, such that at least one component includes four sensors.

An embodiment according to any of the preceding clauses, such that at least one component includes five sensors.

An embodiment according to any of the preceding clauses, such that at least one component includes six sensors.

An embodiment according to any of the preceding clauses, such that at least one component includes six hygrometers for detecting the presence of water and/or water vapor where the six hygrometers are positioned in an enclosed volume between a joining surface on a first component and a joining surface on a second component.

A method of detecting a leak in an assembly. The method includes detecting the presence of an analyte, such as water and/or water vapor, between a joining surface of a first component and a joining surface of a second component. The presence of the analyte is detected by a sensor positioned within a connector region of the first component.

A method of detecting water and/or water vapor. The method includes detecting the presence of water and/or water vapor in an enclosed volume positioned between a joining surface of a first component and a joining surface of a second component. The presence of water and/or water vapor is detected by a hygrometer positioned in the enclosed volume.

A method of detecting water and/or water vapor. The method includes detecting the presence of water and/or water vapor between a joining surface of a first component and a joining surface of a second component. The presence of water and/or water vapor is detected by a hygrometer positioned within a connector region of the first component.

A method of detecting a leak of a fuel including reactive compound. The method includes reacting the reactive compound with a catalyst having a platinum group metal to generate a reaction product, and detecting the reaction product with a sensor. The reactive compound is leaking from a conduit having a flow path for conveying a fuel including the reactive compound, the catalyst is positioned outside of the flow path, and the sensor is in thermal and/or diffusive contact with the hydrogen reaction catalyst.

The method according to the proceeding clause, such that the reaction product is heat, the sensor is a temperature sensor, and the sensor is in thermal contact with the hydrogen reaction catalyst.

The embodiment of any of the preceding clauses, such that the catalyst is a hydrogen reaction catalyst.

The embodiment of any of the preceding clauses, such that the catalyst is a hydrogen combustion catalyst.

The embodiment of any of the preceding clauses, such that the catalyst consists of inorganic compounds.

The embodiment of any of the preceding clauses, such that the catalyst consists of transition metals.

The embodiment of any of the preceding clauses, such that the reactive compound is diatomic hydrogen.

The embodiment of any of the preceding clauses, such that the reactive compound is methane.

The method according to any of the proceeding clauses, such that the reaction product is water and/or water vapor, the sensor is a hygrometer, and the sensor is in diffusive contact with the hydrogen reaction catalyst.

Although the foregoing description is directed to the preferred embodiments, it is noted that other variations and modifications will be apparent to those skilled in the art, and may be made without departing from the spirit or the scope of the disclosure Moreover, features described in connection with one embodiment may be used in conjunction with other embodiments, even if not explicitly stated above.

1. A component comprising:
a conduit region having a flow path to convey a fluid comprising a reactive compound;
a connector region having an external surface and a joining surface to fluidly connect the conduit region to another component; and
a catalyst comprising a platinum group metal, wherein the catalyst is positioned on at least one surface chosen from the joining surface of the connector region, the external surface of the connector, and combinations thereof,
wherein the flow path is free of the catalyst and the catalyst is positioned to contact and to react the reactive compound if the reactive compound escapes the flow path.

2. The component according to claim 1, wherein the connector region is at least one chosen from a flange connector, a barb connector, a bayonet connector, a threaded connector, a swage-lock connector, a v-band connector, a welded connection, a soldered connection, and combinations thereof.

3. The component according to claim 1, wherein the platinum group metal is platinum, palladium, or a combination thereof.

4. The component according to claim 1, further comprising a temperature sensor in thermal contact with the hydrogen reaction catalyst.

5. The component according to claim 1, wherein the catalyst is present in at least one entity chosen from a paint, a coating, a tape, an electroplated surface, a gasket, and combinations thereof.

6. The component according to claim 1, wherein the catalyst further comprises a supporting material for the platinum group metal and the supporting material is chosen from a carbon support, a metal-oxide support, a metal mesh, a ceramic support, an electroplated surface, and combinations thereof.

7. The component according to claim 1, wherein the catalyst comprises nanoparticles comprising the platinum group metal.

8. The component according to claim 1, wherein the conduit region has a double walled region surrounding the flow path and the catalyst is positioned within the double walled region.

9. The component according to claim 1, wherein the reactive compound is diatomic hydrogen.

10. An assembly comprising:
a first component according to claim 1; and
a second component at least partially surrounding the conduit region of the first component,
wherein the catalyst is sandwiched between first component and the second component.

11. The assembly according to claim 10, wherein the first component comprises a threaded region to connect the first component to the second component or to connect the first component to another component.

12. An assembly comprising:
a first component according to claim 1; and
a second component including:
a second component conduit region having a second component flow path to convey the fluid comprising a reactive compound; and
a second component connector region having a joining surface to fluidly connect the second component conduit region to the conduit region of the first component,
wherein the second component flow path is in fluid communication with the flow path of the first component, and
wherein the second component flow path is free of the hydrogen reaction catalyst.

13. The assembly according to claim 12, further comprising a third component in contact with the catalyst and the third component is in contact with both the first component and the second component to position the catalyst transverse to a joint between the first component and the second component.

14. The assembly according to claim 12, wherein the catalyst is in contact with the joining surface of the second component and the catalyst is in contact with the joining surface of the first component.

15. The assembly according to claim 14, wherein the connector region of the first component is a flange, the second component connector region is a flange, and the catalyst is sandwiched between the connector region of the first component and the second component connector region.

16. The assembly according to claim 12, further comprising an at least partially enclosed volume having at least one wall at least partially defined by at least one of the first component or the second component, and wherein the catalyst is in contact with an enclosed portion of the at least partially enclosed volume.

17. The assembly according to claim 16, wherein the at least partially enclosed volume has a tortuous path with the catalyst positioned on a wall of the tortuous path.

18. The assembly according to claim 12, wherein:
the joining surface of the first component is in contact with the joining surface of the second component,
the catalyst is in contact with the first component,
the catalyst is in contact with the second component, and
the catalyst is positioned transverse to the joining surface of the first component and the joining surface of the second component.

19. The assembly according to claim 18, wherein the connector region of the first component is a flange, the second component connector region is a flange, and the catalyst is positioned on an external surface of the flange of the connector region of the first component and the flange of the connector region of the second component.

20. The assembly according to claim 19, wherein the connector region of first component has a protrusion and the second component connector region has a recess, wherein the protrusion fits into the recess, and the catalyst is sandwiched between the protrusion and the recess.
